(19) United States
(12) Patent Application Publication
(10) Pub. No.: US 2024/0259860 A1
(43) Pub. Date: Aug. 1, 2024

(54) PDCP OOOD BEHAVIOR BASED ON RADIO CONFIGURATION AND/OR FLOW CHARACTERISTICS

(71) Applicant: QUALCOMM Incorporated, San Diego, CA (US)

(72) Inventors: Sitaramanjaneyulu KANAMARLAPUDI, San Diego, CA (US); Arnaud MEYLAN, San Diego, CA (US)

(21) Appl. No.: 18/160,945

(22) Filed: Jan. 27, 2023

(51) Int. Cl. H04W 28/02; H04W 28/12

(52) U.S. Cl. CPC H04W 28/0268; H04W 28/12

(57) ABSTRACT

Aspects provide mechanisms for out-of-order delivery (OOOD) of Packet Data Convergence Protocol (PDCP) Protocol Data Units (PDUs) associated with one or more data flows of one or more data radio bearers (DRBs). In various aspects, PDCP OOOD may be configurable at the DRB level or the data flow level based on various flow characteristics. In addition, PDCP OOOD may be configurable at the DRB level based on radio characteristics associated with communication of the PDCP PDUs.

### INTRODUCTION

The technology discussed below relates generally to wireless communication networks, and more particularly, to handling of packets at the packet data convergence protocol (PDCP) sublayer.

In wireless communication systems, such as those specified under standards for 5G New Radio (NR), a user equipment (UE) may be capable of communicating with a network entity within a radio access network. The radio protocol architecture for a radio access network may include various layers, including, for example, a PDCP sublayer.

In 3rd Generation Partnership Project (3GPP) standards, the PDCP sublayer is located in Layer 2 (L2) of the radio protocol stack in both the Long Term Evolution (LTE) and New Radio (NR) air interface on top of a Radio Link Control (RLC) sublayer. The PDCP sublayer provides various services, such as transfer of user and control plane data, header compression, ciphering, and integrity protection. The RLC sublayer provides various services, such as segmentation and reassembly of upper layer data packets, duplicate packet detection, and retransmission of lost data packets. Further improvements in PDCP packet handling may advance wireless communication technologies not only to meet the growing demand for mobile access, but to advance and enhance the user experience with mobile communications.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus for wireless communication at a user equipment (UE) is disclosed including a memory and a processor coupled to the memory. The processor can be configured to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The processor is further configured to enable PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides a method for wireless communication at a user equipment (UE). The method includes receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The method further includes enables PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides a user equipment (UE) including means for receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The UE further includes means for enables PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides a non-transitory computer-readable medium having stored therein instructions executable by one or more processors of a user equipment (UE) to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The non-transitory computer-readable medium further includes instructions executable by the one or more processors of the UE to enable PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides an apparatus for wireless communication at a network entity including a memory and a processor coupled to the memory. The processor can be configured to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The processor is further configured to enable PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides a method for wireless communication at a network entity. The method includes receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The method further includes enables PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides a network entity including means for receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The network entity further includes means for enables PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides a non-transitory computer-readable medium having stored therein instructions executable by one or more processors of a network entity to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The non-transitory computer-readable medium further includes instructions executable by the one or more processors of the network entity to enable PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Another example provides an apparatus for wireless communication at a user equipment (UE) including a memory and a processor coupled to the memory. The processor can be configured to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The processor can further be configured to enable PDCP out-of-order delivery (OOOD) of the plurality of PDCP PDUs associated with each of the one or more DRBs to an upper layer based on radio characteristics associated with communication of the PDCP PDUs.

Another example provides a method for wireless communication at a user equipment (UE). The method includes receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The method further includes enabling PDCP out-of-order delivery (OOOD) of the plurality of PDCP PDUs associated with each of the one or more DRBs to an upper layer based on radio characteristics associated with communication of the PDCP PDUs.

Another example provides a user equipment (UE) including means for receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The UE further includes means for enabling PDCP out-of-order delivery (OOOD) of the plurality of PDCP PDUs associated with each of the one or more DRBs to an upper layer based on radio characteristics associated with communication of the PDCP PDUs.

Another example provides a non-transitory computer-readable medium having stored therein instructions executable by one or more processors of a user equipment (UE) to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The non-transitory computer-readable medium further includes instructions executable by the one or more processors of the UE to enable PDCP out-of-order delivery (OOOD) of the plurality of PDCP PDUs associated with each of the one or more DRBs to an upper layer based on radio characteristics associated with communication of the PDCP PDUs.

Another example provides an apparatus for wireless communication at a network entity including a memory and a processor coupled to the memory. The processor can be configured to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The processor can further be configured to enable PDCP out-of-order delivery (OOOD) of the plurality of PDCP PDUs associated with each of the one or more DRBs to an upper layer based on radio characteristics associated with communication of the PDCP PDUs.

Another example provides a method for wireless communication at a network entity. The method includes receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The method further includes enabling PDCP out-of-order delivery (OOOD) of the plurality of PDCP PDUs associated with each of the one or more DRBs to an upper layer based on radio characteristics associated with communication of the PDCP PDUs.

Another example provides a network entity including means for receiving a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The network entity further includes means for enabling PDCP out-of-order delivery (OOOD) of the plurality of PDCP PDUs associated with each of the one or more DRBs to an upper layer based on radio characteristics associated with communication of the PDCP PDUs.

Another example provides a non-transitory computer-readable medium having stored therein instructions executable by one or more processors of a network entity to receive a plurality of packet data convergence protocol (PDCP) protocol data units (PDUs) from a radio link control (RLC) sublayer. Each of the plurality of PDCP PDUs is associated with a respective data flow of a plurality of data flows, and each data flow of the plurality of data flows is mapped to a respective data radio bearer (DRB) of one or more DRBs. The non-transitory computer-readable medium further includes instructions executable by the one or more processors of the network entity to enable PDCP out-of-order delivery (OOOD) of the plurality of PDCP PDUs associated with each of the one or more DRBs to an upper layer based on radio characteristics associated with communication of the PDCP PDUs.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a radio access network (RAN) according to some aspects.

FIG. 2 is a diagram illustrating a multi-RAT deployment environment according to some aspects.

FIG. 3 is a diagram illustrating an example of a radio protocol architecture for the user and control plane according to some aspects.

FIG. 4 is a diagram illustrating an example of a structure of a Packet Data Convergence Protocol (PDCP) sublayer and a radio link control (RLC) sublayer according to some aspects.

FIG. 5 is a diagram illustrating an exemplary Quality of Service (QoS) architecture according to some aspects.

FIG. 6 is a diagram illustrating an example of a format of a Packet Data Convergence Protocol (PDCP) Packet Data Unit (PDU).

FIG. 7 is a diagram illustrating an example of PDCP manager circuitry according to some aspects.

FIG. 8 is a diagram illustrating an example of a format of a Service Data Adaptation Protocol (SDAP) Packet Data Unit (PDU).

FIG. 9 is a block diagram illustrating an example of a hardware implementation for a user equipment (UE) employing a processing system according to some aspects.

FIG. 10 is a block diagram illustrating an example of a hardware implementation for a network entity employing a processing system according to some aspects.

FIG. 11 is a flow chart illustrating an exemplary method for enabling PDCP out-of-order delivery (OOOD) according to some aspects.

FIG. 12 is a flow chart illustrating another exemplary method for enabling PDCP OOOD according to some aspects.

FIG. 13 is a diagram providing a high-level illustration of one example of a configuration of a disaggregated base station according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

In wireless communication networks, such as those specified under standards for 5G New Radio (NR), protocol data unit (PDU) sessions may be established between a UE and an end device (e.g., an external data network) via a core network. For each PDU session, one or more data radio bearers (DRBs) may be defined specifying the configuration of the transfer of user data traffic between the UE and a radio access network (e.g., a next generation (NG)-RAN). A DRB is a logical communication channel on L2 and higher layers for the transfer of data for a PDU session between the UE and the NG-RAN. A single DRB can serve PDUs, also referred to herein as packets, with the same packet forwarding treatment. The packet forwarding treatment may be defined by a Quality of Service (QoS) applied to each packet (or PDU). Each PDU session may include one or more data flows (e.g., Internet Protocol (IP), Ethernet and/or unstructured data flows), each having a respective QoS associated therewith. As such, each data flow may also be referred to herein as a QoS flow. Each DRB may include one or more QoS flows, each characterized by a QoS profile providing the same packet forwarding treatment on the radio interface (Uu interface).

At the UE and/or the NG-RAN, PDUs may be received at the Packet Data Convergence Protocol (PDCP) sublayer within L2 of the radio protocol stack from the radio link control (RLC) sublayer within L2 of the radio protocol stack and further processed for transfer to upper layers. In both 5G New Radio (NR) standalone networks and non-standalone networks with Evolved-Universal Terrestrial Radio Access New Radio dual connectivity (EN-DC), PDCP reordering or PDCP out-of-order delivery (OOOD) may be enabled to handle missing PDCP PDUs. In PDCP reordering, a reordering timer is initialized upon discovering a missing PDCP PDU. On timer expiry, if the missing PDCP PDU is not recovered, any in-sequence PDCP PDUs after the missing PDCP PDU may be delivered from the PDCP sublayer to the upper layers. In PDCP OOOD, PDCP PDUs are delivered to the upper layers without waiting for the PDCP PDUs to be in-sequence at the PDCP sublayer.

PDCP OOOD is configurable at the data radio bearer (DRB) level, which may then be applied to each data flow within the DRB. For example, each DRB may enable or disable PDCP OOOD. Therefore, each data flow within a DRB that enables PDCP OOOD may also enable PDCP OOOD. Similarly, each data flow within a DRB that disables PDCP OOOD may also disable PDCP OOOD. For latency-sensitive traffic, PDCP OOOD may be desired. However, PDCP OOOD may impact other data flows in the DRB if those flows contain reliability-sensitive traffic. For example, transport control protocol (TCP) traffic or other non-latency traffic may be sensitive to OOOD packets, as this may result in duplicate TCP acknowledgements (DUP ACKs) being sent in the reverse direction, thus causing TCP window scaling issues.

Various aspects of the disclosure provide mechanisms for out-of-order delivery (OOOD) of Packet Data Convergence Protocol (PDCP) Protocol Data Units (PDUs) associated with one or more data flows of one or more data radio bearers (DRBs). In various aspects, PDCP OOOD may be configurable at the DRB level or the data flow level based on various flow characteristics. In addition, PDCP OOOD may be configurable at the DRB level based on radio characteristics associated with communication of the PDCP PDUs.

In some examples, the radio characteristics may include a rate of downlink TCP retransmissions, a scheduling rate and buffering latency at an application layer, a latency of radio link control (RLC) automatic repeat request (ARQ) and/or a number of failed hybrid automatic repeat request (HARQ) retransmissions, and/or a radio condition associated with the UE. For example, the radio condition may include an indication that the UE is a cell edge UE or a cell center UE, a quality of signals received by the UE, or a radio feature supported by the UE (e.g., a higher data rate or a lower data rate).

In some examples, the flow characteristics may include a respective latency indicated by the quality of service (QoS) flow identifier (QFI) of each of the data flows, a number of data flows, a data rate of the data flows, an application type associated with the data flows, a round-trip-time (RTT) of the data flows, and/or a congestion window size associated with the data flows.

In some examples, PDCP OOOD may be enabled or disabled at the data flow level based on the respective QFI of each of the data flows. In an example, the respective latency of each of the data flows may be identified based on the QFI associated with each of the data flows. PDCP OOOD may be enabled or disabled at the data flow level based on the respective latency indicated by the QFI of each of the data flows. For example, PDCP OOOD may be enabled for low-latency data flows and disabled for latency sensitive data flows. In some examples, PDCP OOOD may be enabled or disabled at the DRB level based on a number of data flows of the DRB. In an example, if the number of data flows within a DRB is high (e.g., greater than a threshold), PDCP OOOD may be enabled as long as the individual data flows are not impacted in terms of duplicate TCP acknowledgements (DUP ACKs) on the uplink. In some examples, PDCP OOOD may be enabled or disabled at the data flow level based on a respective data rate of each of the data flows. In an example, PDCP OOOD may be disabled for each data flow having a data rate above a threshold. In some examples, PDCP OOOD may be enabled or disabled at the data flow level based on a respective type of application associated with each of the data flows. In an example, PDCP OOOD may be enabled for low-latency applications. In some examples, PDCP OOOD may be enabled or disabled at the data flow level based on a respective round-trip-time (RTT) of each of the data flows. In an example, PDCP OOOD may be enabled for each data flow for which the respective RTT is below a threshold. In some examples, PDCP OOOD may be enabled or disabled at the DRB level or data flow level based on a respective congestion window size of each of the data flows. In an example, PDCP OOOD may be disabled for data flows for which the congestion window size is above a threshold.

By enabling or disabling PDCP OOOD at the DRB level or the data flow level based on data flow characteristics and/or radio characteristics, PDCP OOOD may be dynamically applied per DRB and/or per data flow and may further be adaptable to radio conditions. As such, the optimal PDCP behavior (e.g., PDCP OOOD or PDCP reordering) may be applied to each data flow and/or DRB, which may reduce latency and DUP ACKs among data flows and/or DRBs.

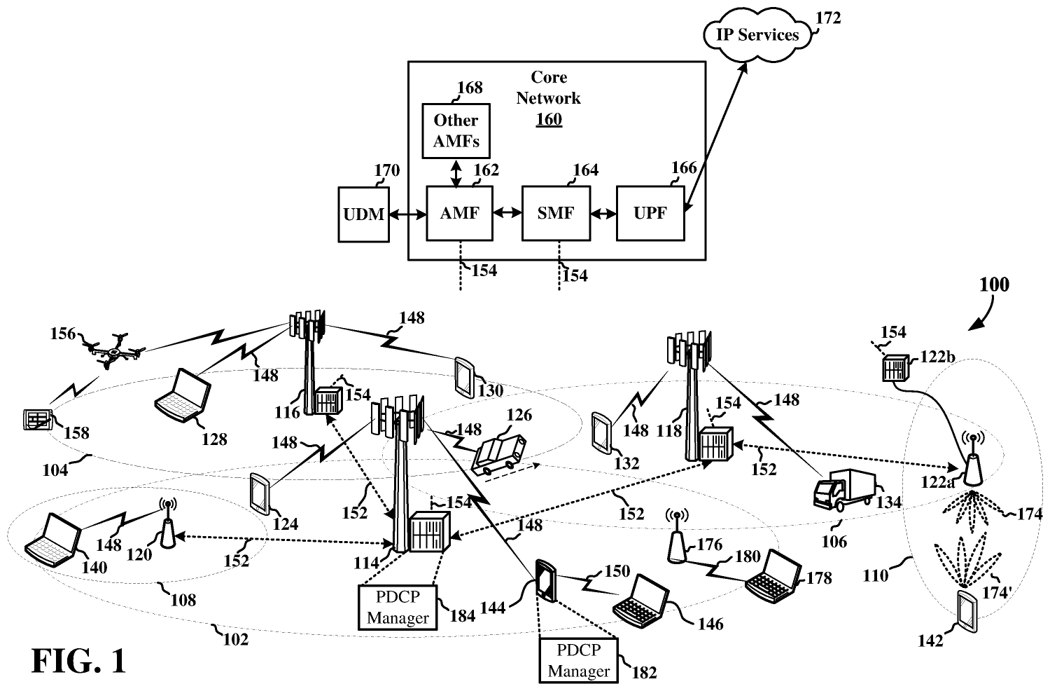

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station, base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile base station such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3^{rd} Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

In some examples, a UE (e.g., 144) and a network entity (e.g., network entity 114) may be configured for packet data convergence protocol (PDCP) out-of-order delivery (OOOD). In the example shown in FIG. 1, each of the UE 144 and network entity 114 may include a PDCP manager 182 and 184, respectively, configured to apply PDCP OOOD to one or more data flows of a data radio bearer (DRB) based on various factors. For example, the PDCP managers 182 and 184 may be configured to apply PDCP OOOD at the DRB level and/or the data flow level based on flow characteristics and/or radio characteristics. The radio characteristics may include, for example, a rate of downlink TCP retransmissions, a scheduling rate and buffering latency at an application layer, a latency of radio link control (RLC) automatic repeat request (ARQ) and/or a number of failed hybrid automatic repeat request (HARQ) retransmissions, and/or a radio condition associated with the UE. The flow characteristics may include, for example, the respective QFI of each of the data flows, a number of data flows, a data rate of the data flows, an application type associated with the data flows, a round-trip-time (RTT) of the data flows, and/or a congestion window size associated with the data flows.

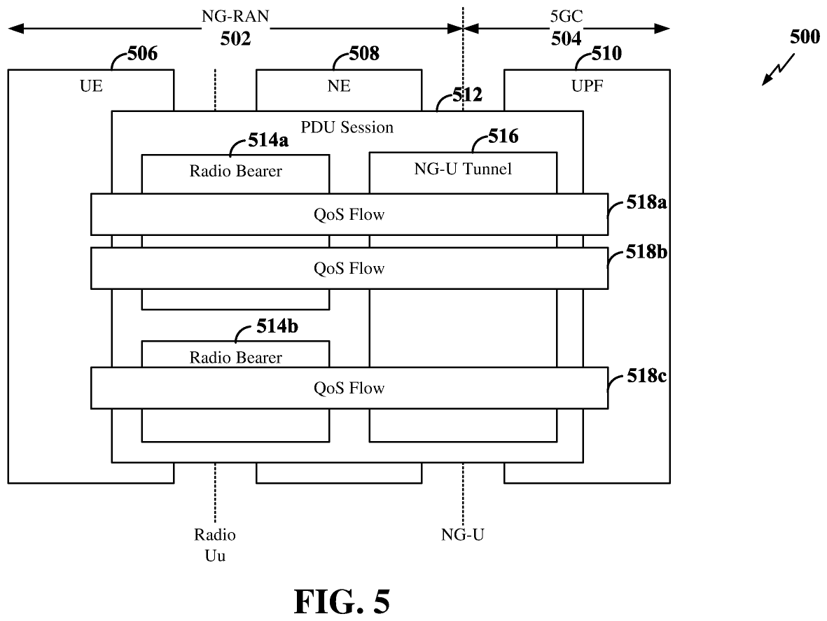

NR 5G wireless communication systems may support one or more frequency ranges, including FR1, FR2 or a legacy LTE frequency range. For example, the LTE frequency range may include the E-UTRA frequency bands between 350 MHz and 3.8 GHz. In some examples, each cell may support a single frequency range (e.g., FR1, FR2 or legacy LTE) and may further support one or more frequency bands (e.g., carrier frequencies) within a particular frequency range. In addition, one or more cells may operate as anchor cells enabling dual connectivity with neighbor cell(s) supporting a different frequency range. In some examples, one or more cells may be NR dual connectivity (NR DC) cells that support dual connectivity between FR1 and FR2 (e.g., FR1+FR2 DC). For example, a NR DC anchor cell may be configured for communication with UEs in the cell over FR1, and may further support dual connectivity by the UEs to enable simultaneous communication over FR1 with the NR DC anchor cell and over FR2 with one or more neighbor NR cells. In other examples, one or more cells may be Evolved-Universal Terrestrial Radio Access New Radio dual connectivity (EN-DC) that support dual connectivity between an LTE frequency band and either FR1 or FR2, as described in more detail below in connection with FIG. 5. For example, an LTE anchor cell may be configured for communication with UEs in the cell over an LTE frequency band, and may further support dual connectivity by the UEs to enable simultaneous communication over the LTE frequency band with the LTE anchor cell and over either FR1 or FR2 with one or more neighbor NR cells.

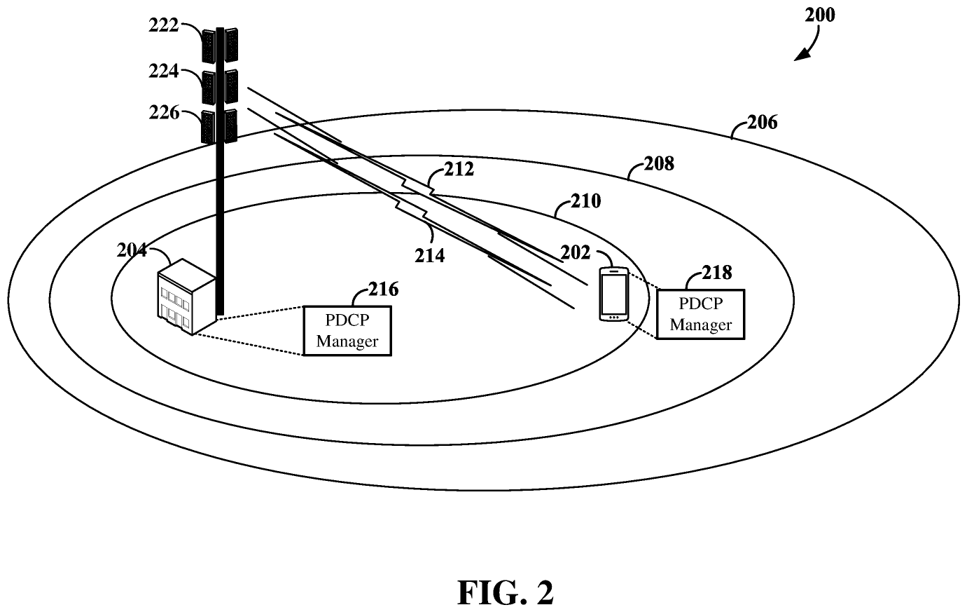

FIG. 2 is a diagram illustrating a multi-radio access technology (RAT) deployment environment 200 according to some aspects. In the multi-RAT deployment environment 200 shown in FIG. 2, a UE 202 may communicate with a network entity 204 using one or more of a plurality of RATs. For example, the network entity 204 may include a plurality of co-located TRPs 222, 224, and 226, each serving a respective cell 206, 208, and 210. Each cell 206, 208, and 210 may enable communication with the UE using a respective RAT and corresponding frequency range. In some examples, the RATs may include LTE and NR. For example, a first cell 206 may be an LTE cell that operates in an LTE frequency range to provide wide area coverage to the UE 202. In addition, a second cell 208 may be a NR cell that operates in a sub-6 GHz frequency range (e.g., FR1), and a third cell 210 may be a NR cell that operates in a mmWave frequency range (e.g., FR2 or higher).

In some examples, the UE 202 may communicate with the network entity 204 over two or more of the cells 206, 208, and 210 in a multi-RAT dual connectivity (MR-DC) mode, such as EN-DC, as described above. EN-DC may be utilized in a non-standalone (NSA) mode of 5G NR in which the UE 202 is simultaneously connected to both LTE and NR or to LTE for the control plane and NR for the user plane. In EN-DC, the LTE cell (e.g., cell 206) may be referred to as the anchor cell that provides a radio resource control (RRC) connection to the UE 202. The anchor cell 206 may activate or add one or more additional NR cells (e.g., cells 208 and/or 210) to provide 2G services to the UE 202. In an example, as shown in FIG. 2, the UE 202 may simultaneously communicate with the LTE anchor cell 206 over a first wireless interface 212 using an LTE frequency band and with a neighbor NR cells (e.g., cell 208) over a second wireless interface 214 using FR1.

In other examples, the UE 202 may communicate with the network entity 204 in a NR standalone (SA) mode in which LTE is not utilized as the anchor cell. For example, the UE 202 may communicate with the network entity 204 in a NR DC mode. As described above, NR DC mode supports dual connectivity between FR1 and FR2 (e.g., FR1+FR2 DC). For example, a UE 202 may be configured for simultaneous communication with an NR anchor cell 208 over FR1 and with one or more neighbor NR cells (e.g., cell 210) over FR2. In other examples, the UE 202 may be configured to communicate over a single one of the NR cells (e.g., cell 208 or 210) using FR1 or FR2.

In some examples, the UE 202 and the network entity 204 may be configured for packet data convergence protocol (PDCP) outo-of-order delivery (OOOD). In the example shown in FIG. 2, each of the UE 202 and network entity 204 may include a PDCP manager 216 and 218, respectively, configured to apply PDCP OOOD to one or more data flows of a data radio bearer (DRB) based on various factors. For example, the PDCP managers 216 and 218 may be configured to apply PDCP OOOD at the DRB level and/or the data flow level based on flow characteristics and/or radio characteristics. The radio characteristics may include, for example, a rate of downlink TCP retransmissions, a scheduling rate and buffering latency at an application layer, a latency of radio link control (RLC) automatic repeat request (ARQ) and/or a number of failed hybrid automatic repeat request (HARQ) retransmissions, and/or a radio condition associated with the UE. The flow characteristics may include, for example, the QFI of each of the data flows, a number of data flows, a data rate of the data flows, an application type associated with the data flows, a round-trip-time (RTT) of the data flows, and/or a congestion window size associated with the data flows.

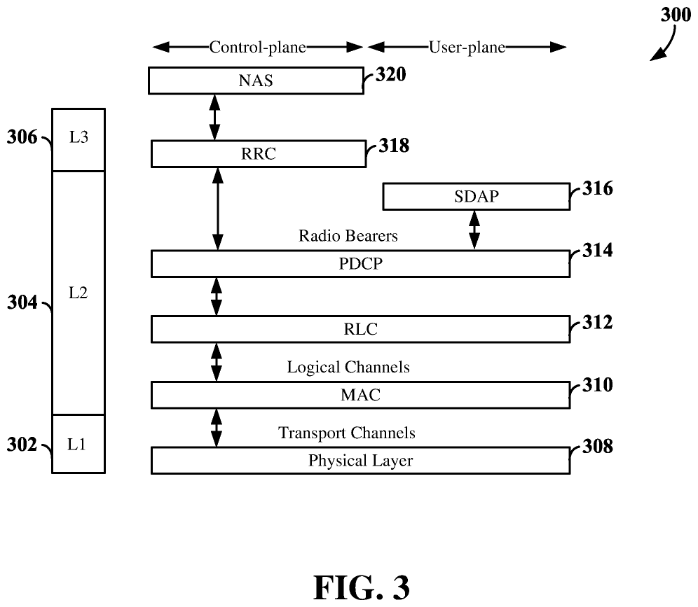

The radio protocol architecture for a radio access network, such as the radio access network 100 shown in FIG. 1 and/or the radio access network 200 shown in FIG. 2 may take on various forms depending on the particular application. An example for a NR radio access network will now be presented with reference to FIG. 3. FIG. 3 is a conceptual diagram illustrating an example of the radio protocol architecture for the user and control planes.

As illustrated in FIG. 3, the radio protocol architecture 300 for each of the UE and the network entity includes three layers: layer 1 (L1) 302, layer 2 (L2) 304, and layer 3 (L3) 306. L1 is the lowest layer and implements various physical layer signal processing functions. L1 will be referred to herein as the physical layer 308. L2 304 is above the physical layer 308 and is responsible for the link between the UE and network entity over the physical layer 308.

In the user plane, the L2 layer 304 includes a media access control (MAC) sublayer 310, a radio link control (RLC) sublayer 312, a packet data convergence protocol (PDCP) 314 sublayer, and a service data adaptation protocol (SDAP) sublayer 316, which are terminated at the network entity on the network side. Although not shown, the UE may have several upper layers above the L2 layer 304 including at least one network layer (e.g., IP layer and user data protocol (UDP) layer) that is terminated at the User Plane Function (UPF) on the network side and one or more application layers.

The SDAP sublayer 316 provides a mapping between a 5G core (5GC) quality of service (QoS) flow and a data radio bearer and performs QoS flow ID marking in both downlink and uplink packets. The PDCP sublayer 314 provides packet sequence numbering, in-sequence or out-of-sequence delivery of packets, retransmission of PDCP protocol data units (PDUs), re-ordering of received PDCP PDUs, and transfer of upper layer data packets to lower layers. PDU's may include, for example, Internet Protocol (IP) packets, Ethernet frames and other unstructured data (i.e., Machine-Type Communication (MTC), hereinafter collectively referred to as “packets”). The PDCP sublayer 314 also provides header compression for upper layer data packets to reduce radio transmission overhead, security by ciphering/deciphering the data packets, and integrity protection of data packets. A PDCP context may indicate whether PDCP duplication is utilized for a unicast connection.

The RLC sublayer 312 provides segmentation and reassembly of upper layer data packets, error correction through automatic repeat request (ARQ), duplicate packet detection, and sequence numbering independent of the PDCP sequence numbering. An RLC context may indicate whether an acknowledged mode (e.g., a reordering timer is used) or an unacknowledged mode is used for the RLC sublayer 312. The MAC sublayer 310 provides multiplexing between logical and transport channels. The MAC sublayer 310 is also responsible for allocating the various radio resources (e.g., resource blocks) in one cell among the UEs and for HARQ operations. A MAC context may enable, for example, a HARQ feedback scheme, resource selection algorithms, carrier aggregation, beam failure recovery, or other MAC parameters for a unicast connection. The physical layer 308 is responsible for transmitting and receiving data on physical channels (e.g., within slots). A PHY context may indicate a transmission format and a radio resource configuration (e.g., bandwidth part (BWP), numerology, etc.) for a unicast connection.

In the control plane, the radio protocol architecture for the UE and network entity is substantially the same for L1 302 and L2 304 with the exception that there is no SDAP sublayer in the control plane and there is no header compression function for the control plane. The control plane also includes a radio resource control (RRC) sublayer 318 in L3 and a higher Non-Access Stratum (NAS) layer 320. The RRC sublayer 318 is responsible for establishing and configuring signaling radio bearers (SRBs) and data radio bearers (DRBs) between the network entity and the UE, paging initiated by the 5GC or NG-RAN, and broadcast of system information related to Access Stratum (AS) and Non-Access Stratum (NAS). An SRB is a logical communication channel on Layer 2 (L2) of the radio protocol stack and higher layers for the transfer of control information between the UE and the NG-RAN. A DRB is a logical communication channel on L2 and higher layers for the transfer of data for a PDU session between the UE and the NG-RAN. The RRC sublayer 318 is further responsible for QoS management, mobility management (e.g., handover, cell selection, inter-RAT mobility), UE measurement and reporting, and security functions. The NAS layer 320 is terminated at the AMF in the core network and performs various functions, such as authentication, registration management, and connection management.

In general, packets received by a sublayer from an upper sublayer may be referred to as Service Data Units (SDUs), while packets output from a sublayer to a lower sublayer may be referred to as Protocol Data Units (PDUs). For example, packets received by the PDCP sublayer 314 from an upper sublayer may be referred to as PDCP SDUs, and packets output from the PDCP sublayer 314 to the RLC sublayer 312 may be referred to as PDCP PDUs or RLC SDUs. As used herein, the terms PDCP PDU and RLC SDU may be used interchangeably.

The PDCP sublayer 314 may further be configured to apply PDCP reordering or PDCP out-of-order delivery (OOOD) to handle missing PDCP PDUs. In PDCP reordering, a reordering timer (Treordering) is initialized upon discovering a missing PDCP PDU. On timer expiry, all in-sequence PDCP PDUs received after the missing PDCP PDU may be delivered from the PDCP sublayer 314 to the upper layers. In PDCP OOOD, PDCP PDUs are delivered to the upper layers without waiting for the PDCP PDUs to be in-sequence at the PDCP sublayer.

In various aspects, the PDCP sublayer 314 may be configured to enable or disable PDCP OOOD for one or more data flows of one or more DRBs based on flow characteristics and/or radio characteristics. In examples in which the PDCP sublayer 314 disables PDCP OOOD for one or more data flows, the PDCP sublayer 314 may be configured to apply PDCP reordering to those one or more data flows to handle any missing PDCP PDUs. The radio characteristics may include, for example, a rate of downlink TCP retransmissions, a scheduling rate and buffering latency at an application layer, a latency of radio link control (RLC) automatic repeat request (ARQ) and/or a number of failed hybrid automatic repeat request (HARQ) retransmissions, and/or a radio condition associated with the UE. The flow characteristics may include, for example, the QFI of each of the data flows, a number of data flows, a data rate of the data flows, an application type associated with the data flows, a round-trip-time (RTT) of the data flows, and/or a congestion window size associated with the data flows.

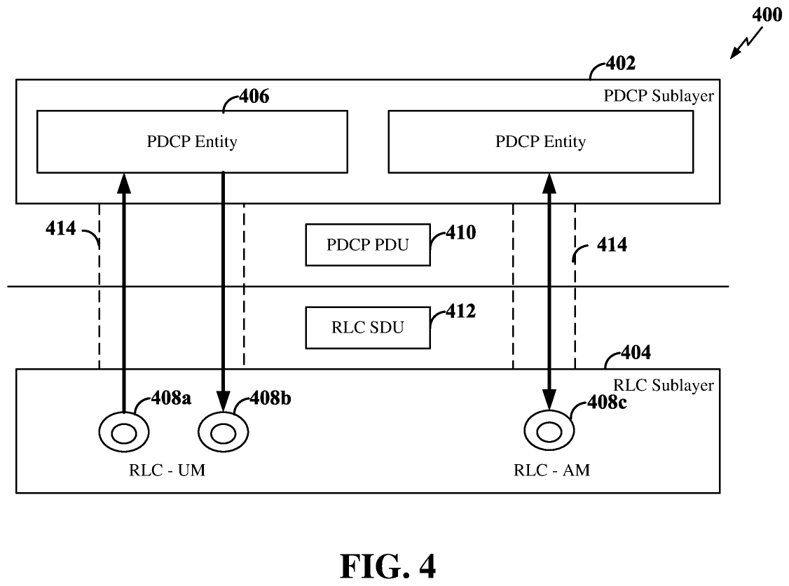

FIG. 4 is a diagram illustrating an example of a structure 400 of a Packet Data Convergence Protocol (PDCP) sublayer 402 and radio link control (RLC) sublayer 404 according to some aspects. The PDCP sublayer 402 includes one or more PDCP entities 406 defined for a device (e.g., a UE). In addition, the RLC sublayer 404 includes one or more RLC entities 408 defined for the UE. Each PDCP entity 406 carries data for one radio bearer 414 (e.g., data radio bearer (DRB), sidelink radio bearer (SRB), or signaling radio bearer (SRB)). A PDCP entity 406 is, therefore, associated to either the control plane or the user plane depending on the radio bearer 414 for which it is carrying data.

Each PDCP entity 406 is associated with one, two, or four (e.g., uni-directional/bi-directional or split/non-split) RLC entities 408a-408c depending on the radio bearer characteristics (e.g., uni-directional or bi-directional) or the RLC mode. Here, the RLC mode may be either the transparent mode (TM), unacknowledged mode (UM mode) or acknowledged mode (AM). The TM is used for SRB0, paging, and broadcast of system information. The UM may be used, for example, to transmit delay sensitive packets, such as VoIP packets. In the UM, the receiving device does not acknowledge reception of data packets to the transmitting device (e.g., the receiving device does not transmit ACK/NACK to the transmitting device). The AM supports a HARQ/ARQ mechanism to retransmit lost PDUs.

For split bearers (e.g., in dual-connectivity (DC) mode) or for radio bearers configured with PDCP duplication, each PDCP entity is associated with two bi-directional AM RLC entities. For LTE-WLAN (LWA) bearers, each PDCP entity 406 is associated with one (bi-directional) AM RLC entity or two (uni-directional) UM RLC entities. For dual active protocol stack (DAPS) bearers, each PDCP entity is associated with two UM RLC entities (for same direction, one for source and one for target cell), four uni-directional UM RLC entities (two for each direction on source cell and target cell), or two bi-directional AM RLC entities (one for source cell and one for target cell). Otherwise, each PDCP entity is associated with one bi-directional UM RLC entity, two uni-directional UM RLC entities, or one bi-directional AM RLC entity. In the example shown in FIG. 4, one of the PDCP entities 406 is associated with two uni-directional UM RLC entities 408a/408b, while the other PDCP entity 406 is associated with a bi-directional AM RLC entity 408c.

The PDCP entities 406 and corresponding RLC entities 408 exchange PDCP PDUs 410, which may also be referred to as RLC SDUs 412. For example, a PDCP entity 406 may receive a PDCP PDU 410/RLC SDU 412 from a corresponding RLC entity 408. One of the functions provided by the PDCP sublayer 402 is deciphering of PDCP PDUs 410 received from the RLC sublayer 404. The ciphering and deciphering of packets are based on the packet COUNT value of the PDCP PDU 410. For example, a packet may be ciphered using a COUNT value generated by the transmitting side PDCP sublayer and deciphered using a COUNT value expected by a receiving side PDCP sublayer. In principle, the COUNT value is not reused during a session, and therefore the COUNT space is long, e.g., 32 bits. To reduce overhead, the transmitter and the receiver communicate the COUNT value of a packet by including only part of the COUNT value corresponding to the sequence number of a packet in the PDCP header. The sequence number (SN) has a smaller space, e.g. 7 bits or 12 bits. The transmitter and receiver also locally maintain a hyper frame number (HFN), which is incremented by 1 each time the SN wraps around. The COUNT value of a packet may thus be calculated by concatenating the locally maintained HFN with the SN received in the packet.

The PDCP entity 406 can receive PDCP PDUs 410 from the RLC entity 408 with or without holes (e.g., missing one or more PDCP PDUs within a range of PDCP PDUs). In NR standalone mode, PDCP holes may arise when there is a missing RLC PDU. In dual connectivity (e.g., EN-DC or NR DC), there is a split radio bearer, and as such there are two RLC entities 408 associated with a single PDCP entity 406. In this case, in addition to missing RLC PDUs, PDCP holes may arrive when one RLC entity (e.g., an FR2 RLC entity) receives RLC PDUs faster than the other RLC entity (e.g., an FR1 or LTE RLC entity) due to, for example, HARQ retransmission delays specific to one of the RATs, RLC retransmission delays specific to one of the RATs, or scheduling delays between RATs.

If the PDCP entity 406 receives a PDCP PDU 410 from the RLC entity 408 without holes (e.g., without one or more missing PDCP PDUs before it), the PDCP entity 406 can deliver the corresponding PDCP SDU to the upper layer. However, if the PDCP entity 406 receives a PDCP PDU 410 with at least one missing PDCP PDU before it, the PDCP entity 406 may be configured to either implement a reordering timer (Treordering) or to apply PDCP out-of-order delivery (OOOD) behavior to the PDCP PDUs. In examples in which a reordering timer is applied (e.g., in Treordering mode), the PDCP entity 406 does not deliver the corresponding PDCP SDU to the upper layer, but rather starts the reordering timer and holds the received PDCP PDU until the missing PDCP PDU(s) are received or the reordering timer expires. For example, upon expiration of the reordering timer, the PDCP entity 406 can ignore missing PDCP PDUs and deliver the PDCP SDUs corresponding to the received PDCP PDUs during the reordering timer duration to the upper layer.

In examples in which PDCP OOOD behavior is applied (e.g., in PDCP OOOD mode), the PDCP entity 406 may deliver the corresponding PDCP SDUs to the upper layer without waiting for the PDCP PDUs to be in order. For example, the PDCP OOOD mode may be applied when applications already have redundancy through forward error correction (FEC), network coding (e.g., Fountain codes), or other mechanisms. As another example, PDCP OOOD mode may be applied when applications have a tolerance to some packet loss and latency is a priority. In an example, skipped frames in video applications may be more acceptable than delayed frames from a user experience perspective.

Thus, PDCP OOOD and Treordering modes serve different use cases and provide different data path behavior to the clients using the connectivity provided by the modem, such as the applications running at the high level operating system (HLOS) level, tethered clients or applications running on the modem processor itself. As a result, a receiving device may select either PDCP OOOD mode or Treordering mode for a DRB based on the packet loss tolerance, latency requirements, and other suitable factors associated with the data flows mapped to the DRB. With the evolution of low-latency applications (e.g., cloud gaming, extended reality (XR), augmented reality (AR), virtual reality (VR), etc.), in which multiple applications are simultaneously interacting at the edge-to-edge (E2E) level over cellular networks and being mapped together into a common DRB, managing the PDCP OOOD requirements for one application, while also considering the reordering buffer logistics for another application mapped to the same DRB may be difficult to implement at the DRB level. For example, turning PDCP OOOD mode on for all flows or for none of the flows may result in a poor user experience for one or more of the applications mapped to the same DRB. In an example, turning on PDCP OOOD mode based on the latency requirements of an XR/VR application may impact other data flows if those flows contain reliability-sensitive traffic. For example, transport control protocol (TCP) traffic or other non-latency traffic may be sensitive to OOOD packets, as this may result in duplicate TCP acknowledgements (ACKs) being sent in the reverse direction, thus causing TCP window scaling issues.

Various aspects are directed to mechanisms for each PDCP entity 406 to enable or disable PDCP OOOD per data flow served by the PDCP entity 406 or per DRB served by the PDCP entit(ies) 406. For example, PDCP OOOD may be enabled or disabled at the DRB level and/or the data flow level based on flow characteristics and/or radio characteristics. The radio characteristics may include, for example, a rate of downlink TCP retransmissions, a scheduling rate and buffering latency at an application layer, a latency of radio link control (RLC) automatic repeat request (ARQ) and/or a number of failed hybrid automatic repeat request (HARQ) retransmissions, and/or a radio condition associated with the UE. The flow characteristics may include, for example, the QFI of each of the data flows, a number of data flows a data rate of the data flows, an application type associated with the data flows, a round-trip-time (RTT) of the data flows, and/or a congestion window size associated with the data flows.

FIG. 5 is a diagram illustrating an exemplary QoS architecture 500 according to some aspects. In some examples, the QoS architecture 500 is implemented within a next generation RAN (e.g., NG-RAN) 502, both for New Radio (NR) connected to a 5G core network (5GC) 504 and for E-UTRA connected to the 5GC. The NG-RAN 502 includes a user equipment (UE) 506 and a network entity (NE) (e.g., a next generation (ng)-eNB or gNB) 508, while the 5GC includes a user plane function (UPF) 510. The 5GC 504 may further include other core network, as illustrated in FIG. 1.

For each UE (e.g., UE 506), the 5GC 504 establishes one or more PDU Sessions 512. Each PDU session 512 may include one or more data flows 518a-518c (e.g., IP, Ethernet and/or unstructured data flows), each associated with a set of one or more applications. The 5GC 504 may further select a QoS to be associated with each of the data flows 518a-518c within the PDU session 512. At the NAS level, the QoS flow is the finest granularity of QoS differentiation in a PDU session and is characterized by both a QoS profile provided by the 5GC 504 to the NE 508 and QoS rule(s) provided by the 5GC 504 to the UE 506. The QoS profile is used by the NE 508 to determine the treatment on the radio interface, while the QoS rules dictate the mapping between uplink User Plane traffic and QoS flows 518a-518c to the UE 506.

The QoS profile may include one or more QoS parameters. For example, the QoS profile may include an allocation and retention priority (ARP), which may indicate the priority level for the allocation and retention of data radio bearers, and a 5G QoS Identifier (5QI), which is associated with particular 5G QoS characteristics. Examples of 5G QoS characteristics may include a resource type (e.g., Guaranteed Bit Rate (GBR), delay critical GBR, or non-GBR), a priority level, a packet delay budget, a packet error rate, an averaging window, and a minimum data burst volume. For GBR QoS flows, the QoS profile may further specify a guaranteed flow bit rate (GFBR) for both uplink and downlink, a maximum flow bit rate (MFBR) for both uplink and downlink, and a maximum packet loss rate for both uplink and downlink. For non-GBR QoS flows, the QoS profile may include a reflective QoS attribute (RQA). The RQA, when included, indicates that some (not necessarily all) traffic carried on this QoS flow is subject to reflective QoS (RQoS) at the NAS layer. Standardized or pre-configured 5G QoS characteristics are derived from the 5QI value and are not explicitly signaled. Signaled QoS characteristics are included as part of the QoS profile.

In addition, an Aggregate Maximum Bit Rate is associated with each PDU session 512 (Session-AMBR) and with each UE 506 (UE-AMBR). The Session-AMBR limits the aggregate bit rate that can be expected to be provided across all Non-GBR QoS Flows for a specific PDU Session 512. The UE-AMBR limits the aggregate bit rate that can be expected to be provided across all Non-GBR QoS Flows of a UE.

The NE 508 establishes one or more Data Radio Bearers (DRB) 514a and 514b per PDU Session 512. The NE 508 further maps packets belonging to different PDU sessions 512 to different DRBs. Here, the NE 508 establishes at least one default DRB (e.g., DRB 514a) for each PDU Session 512. At the Access Stratum (AS) level, the DRB defines the packet treatment on the radio interface (Uu). A DRB serves packets with the same packet forwarding treatment. Separate DRBs may be established for QoS flows requiring different packet forwarding treatment, or several QoS flows belonging to the same PDU session can be multiplexed in the same DRB. Within each PDU session 512, the NE 508 determines how to map multiple QoS flows to a DRB. For example, the NE 508 may map a GBR flow and a non-GBR flow, or more than one GBR flow to the same DRB. The timing of establishment of non-default DRB(s) (e.g., DRB 514b) between the NE 508 and UE 506 for QoS flow(s) configured during establishing a PDU session can be different from the time when the PDU session is established.

The NG-RAN 502 and 5GC 504 ensure quality of service (e.g., reliability and target delay) by mapping packets to appropriate QoS Flows 518a-518c and DRBs 514a and 514b. The NAS layer performs packet filtering in both the UE 506 and in the 5GC 504 to associate uplink (UL) and downlink (DL) packets with QoS Flows 518a-519c. The AS layer, which is a functional layer between the UE 506 and the NE 508, implements mapping rules in the UE 506 and in the NE 508 to associate UL and DL QoS flows 518a-518c with DRBs 514a and 514b. Hence, there is a two-step mapping of IP flows to QoS flows (in the NAS) and from QoS flows to DRBs (in the AS). In the example shown in FIG. 5, QoS flows 518a and 518b are mapped to DRB 514a, while QoS flow 518c is mapped to DRB 514b.

Each QoS flow 518a-518c is identified within the PDU session 512 by a QoS Flow ID (QFI) carried in an encapsulation header (e.g., within an SDAP header) over a next generation tunnel (NG-U tunnel) 516 provided on an interface between the NE 508 and the UPF 510 (NG-U). The QoS flow to DRB mapping by NE 508 is based on the QFI and the associated QoS profiles (i.e., QoS parameters and QoS characteristics). For example, in the uplink, the NE 508 may control the mapping of QoS Flows 518a-518c to DRBs 514a and 514b using reflective mapping or explicit configuration. In reflective mapping, for each DRB 514a and 514b, the UE 506 monitors the QFI(s) of the downlink packets and applies the same mapping in the uplink. That is, for a DRB (e.g., DRB 514a), the UE 506 maps the uplink packets belonging to the QoS flows(s) 518a and 518b corresponding to the QFI(s) and PDU Session 512 observed in the downlink packets for that DRB 514a. To enable this reflective mapping, the NE 508 marks downlink packets over the radio interface (Uu) with the QFI. In an explicit configuration, the NE 508 may configure by RRC an uplink QoS Flow to DRB mapping. The UE 506 may apply the latest update of the mapping rules regardless of whether the update is performed via reflecting mapping or explicit configuration.

In the downlink, the QFI is signaled by the NE 508 over the radio interface (Uu), and if neither the NE 508, nor the NAS (as indicated by the RQA), intend to use reflective mapping for the QoS flow(s) carried in a DRB, no QFI is signaled for that DRB over Uu. However, the NE 508 can configure the UE 506 to still signal the QFI over Uu. As indicated above, for each PDU session 512, a default DRB (e.g., DRB 514a) is configured. If an incoming UL packet matches neither an RRC configured nor a reflective configured QoS Flow ID to DRB mapping. the UE 506 may map the UL packet to the default DRB 514a of the PDU session 512.

Upon establishment of the PDU session, the UE may be configured (e.g., using a control message from the NE) to map a first QoS flow to a first DRB (e.g., 514a). The UE may further be configured to map a second QoS flow to a second DRB (514b). The NAS layer may then perform packet filtering to associate UL packets with QoS Flows. For example, a NAS layer may associate packets from a service data flow (SDF) to the first QoS flow, and packets from other SDFs to respective other QoS flows.

A wireless network (e.g., 5G NR) may be configured to implement packet re-reordering functionality at the PDCP layer or PDCP OOOD functionality. These mechanisms mitigate, to some extent, packet transmission issues resulting from packet drop in the wireless link. However, applying PDCP OOOD mode for all data flows or for none of the data flows may result in a poor user experience for one or more of the applications mapped to the same DRB. Therefore, aspects are directed to enablement/disablement of PDCP OOOD at the data flow level and/or DRB level based on flow characteristics and/or radio characteristics. The radio characteristics may include, for example, a rate of downlink TCP retransmissions, a scheduling rate and buffering latency at an application layer, a latency of radio link control (RLC) automatic repeat request (ARQ) and/or a number of failed hybrid automatic repeat request (HARQ) retransmissions, and/or a radio condition associated with the UE. The flow characteristics may include, for example, the QFI of each of the data flows, a number of data flows, a data rate of the data flows, an application type associated with the data flows, a round-trip-time (RTT) of the data flows, and/or a congestion window size associated with the data flows.

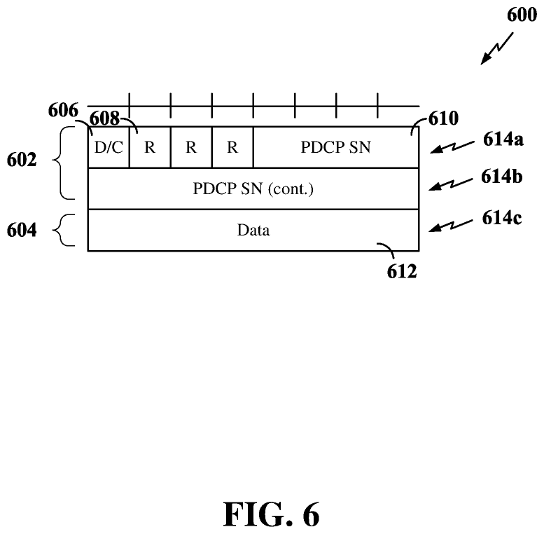

An example of a PDCP packet data unit (PDU) format is illustrated in FIG. 6. The PDCP PDU format 600 includes a header 602 and body 604. The header 602 includes a data/control (D/C) field 606, three reserved fields 608, and a sequence number (SN) field 610. The D/C field 606 is located within a first octet 614a and may include, for example, a single bit for indicating whether the PCDP PDU contains user plane data or control plane data. In the example shown in FIG. 6, the SN field 610 occupies the remainder of the first octet 614a, along with a second octet 614b. The SN field 610 contains the sequence number (SN) of the PDCP PDU. In some examples, the SN may contain 6 bits or 12 bits. The body 604 contains uncompressed or compressed user or control plane data 612 and may include one or more octets (only one octet 614c of which is shown for simplicity).

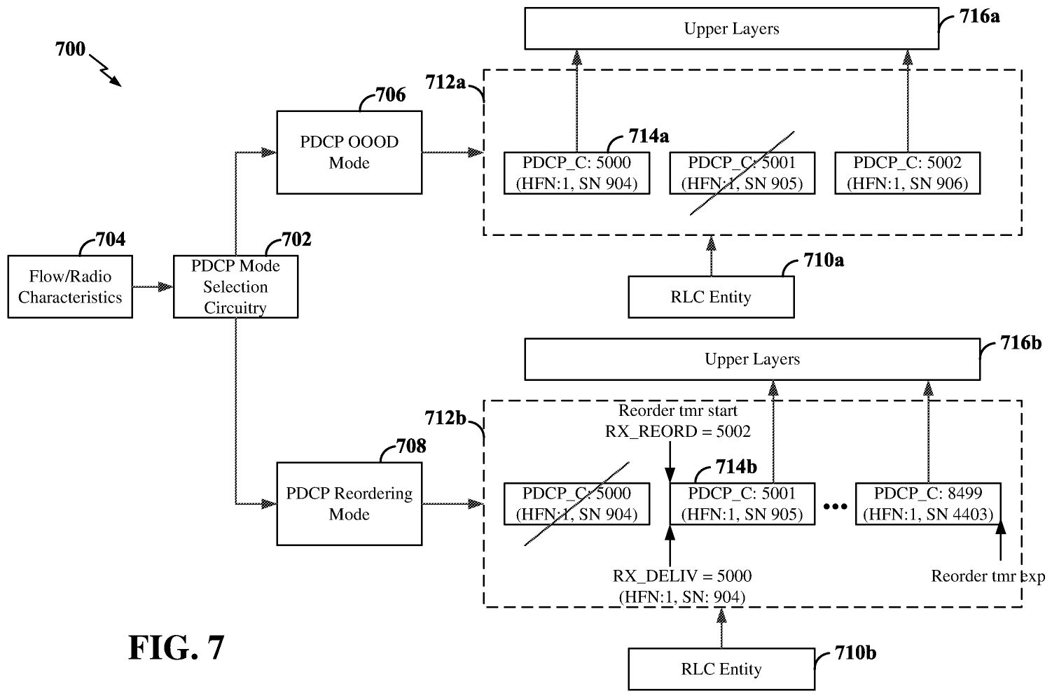

FIG. 7 is a diagram illustrating an example of PDCP manager circuitry 700 according to some aspects. The PDCP manager circuitry 700 includes PDCP mode selection circuitry 702 configured to select between a PDCP OOOD mode 706 and a PDCP reordering mode (Treordering mode) 708. In the PDCP OOOD mode 706, a plurality of PDCP PDUs 714a are delivered from an RLC entity 710a to a PDCP entity 712a. For example, a first PDCP PDU 714a with a sequence number (SN) of 904 is shown successfully delivered to the PDCP entity 712a from the RLC entity 710a. The PDCP entity 712a can then calculate a COUNT value (e.g., PDCP_C: 5000) for the first PDCP PDU 714a using the stored HFN (e.g., HFN=1) and the SN=904. The next PDCP PDU received by the PDCP entity 712a has a COUNT value of 5002 (PDCP_C: 5002), which is received with a hole corresponding to missing PDCP PDU of COUNT value=5001. In PDCP OOOD mode 706, the PDCP entity 712a delivers both received PDCP PDUs 714a (e.g., PDCP_C: 5000 and PDCP_C: 5002) to upper layers 716a without waiting to receive the missing PDCP PDU (e.g., PDCP_C: 5001).

In the PDCP reordering mode 708, a plurality of PDCP PDUs 714b are delivered from an RLC entity 710b to a PDCP entity 712b. For example, a PDCP PDU 714b with a sequence number (SN) of 905 and COUNT value of 5001 is shown successfully delivered to the PDCP entity 712b from the RLC entity 710b, which is received with a hole corresponding to missing PDCP PDU of COUNT value=5000. In PDCP reordering mode, the PDCP entity 712b sets a parameter RX_DELIV to the COUNT value of the first missing PDCP PDU (e.g., PDCP PDU with a PDCP_C=5000). In addition, the PDCP entity 712b initializes a Reordering timer (t-Reordering) and sets a state variable RX_REORD to the COUNT value following the COUNT value associated with the PDCP PDU that triggered t-Reordering. Here, the PDCP entity 712b sets RX_REORD to 5002, which is the COUNT value of the PDCP PDU following the PDCP PDU (e.g., PDCP_C: 5001) that triggered t-Reordering. The PDCP entity 712b continues to receive PDCP PDUs 714b from the RLC entity 710b and calculates the COUNT value of each of the received PDCP PDUs 714b as 5002-8499. After reception of PDCP PDU with a COUNT value of 8499, the reordering timer expires, and the PDCP entity 712b delivers all received PDCP PDUs before RX_REORD (e.g., PDCP_C: 5001 and PDCP_C: 5000 if this PDCP PDU is received prior to expiration of the reordering timer) and all consecutive PDCP PDUs received from RX_REORD (e.g., PDCP_C: 5002) to the PDCP PDU with a COUNT value of 8499 to upper layers 716b.

Thus, in the PDCP OOOD mode 706, PDCP PDUs are delivered from the PDCP entity 712a to upper layers 716a immediately upon reception without waiting for any missing PDCP PDUs, whereas in PDCP Reordering mode 708, the PDCP entity 712b attempts to fill any missing holes prior to delivering PDCP PDUs to the upper layers 716b. To select the proper mode (e.g., PDCP OOOD mode 706 or PDCP reordering mode) at the DRB level and/or the data flow level, the PDCP mode selection circuitry 702 considers the flow/radio characteristics 704 associated with each DRB and/or each data flow.

In some examples, the PDCP mode selection circuitry 702 may select (e.g., enable) the PDCP OOOD mode 706 for one or more data flows of a DRB based on data flow characteristics 704. The data flow characteristics 704 may include, for example, at least one of the respective QFI of each the one or more data flows indicating a respective latency thereof, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

For example, the PDCP mode selection circuitry 702 may enable the PDCP OOOD mode 706 based on the respective 1QFI of each of the one or more data flows included within a respective service data adaption protocol (SDAP) header of a respective SDAP packet for each of the data flows. Thus, in this example, PDCP OOOD mode 706 may be enabled at the data flow level (e.g., per data flow) based on the respective latency of each of the data flows, as indicated by the respective QFI.

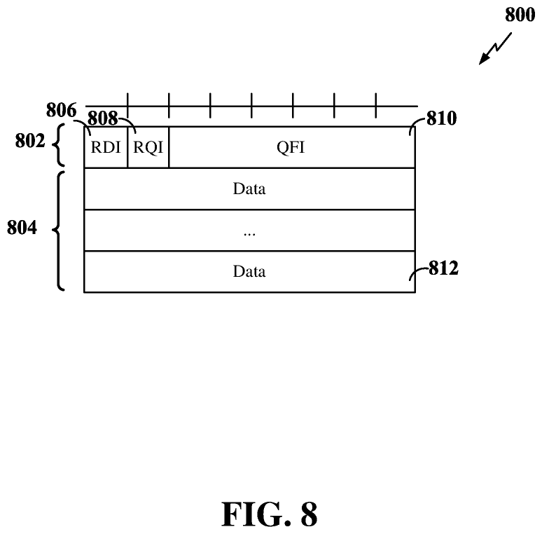

An example of a SDAP packet data unit (PDU) format is illustrated in FIG. 8. The SDAP PDU format 800 includes a header 802 and body 804. The header 802 includes a reflective QoS flow to DRB mapping indication (RDI) field 806, a reflective QoS indication (RQI) field 808, and a QFI field 810. The RDI field 806 and RQI field 808 are each located within a first octet of the SDAP PDU and may each include, for example, a single bit. The QFI field 810 is further included within the first octet and may include, for example, six bits, which are used to identify the QoS flow. When the RDI field is set to one, the UE may update the QoS flow to DRB mapping for the uplink. When the RQI field is set to one, the UE may inform the NAS layer that service data flow (SDF) to QoS mapping rules have been updated. The body 804 contains uncompressed or compressed user or control plane data 812 and may include one or more octets.

Returning to the example shown in FIG. 7, the PDCP mode selection circuitry 702 may enable the PDCP OOOD mode 706 for each of the one or more data flows of the DRB (e.g., all data flows of the DRB) based on the number of data flows of the DRB. In this example, if the number of data flows within a DRB is high (e.g., greater than a threshold), the PDCP OOOD mode 706 may be enabled for the DRB as long as the individual data flows are not impacted in terms of duplicate TCP acknowledgements (DUP ACKs) on the uplink. For example, the PDCP mode selection circuitry 702 may enable the PDCP OOOD mode 706 for each of the one or more data flows of the DRB (e.g., all data flows of the DRB) if the number of data flows of the DRB is above a first threshold and the periodicity of DUP ACKs across the data flows is less than a second threshold. Thus, if one or more data flows of the DRB is experiencing frequent DUP ACKs (e.g., greater than or equal to the second threshold), the PDCP OOOD mode 706 may be disabled and the PDCP mode selection circuitry 702 may instead select the PDCP Reordering mode 708.

As another example, the PDCP mode selection circuitry 702 may enable the PDCP OOOD mode 706 at the data flow level based on a respective data rate of each of the data flows. In an example, the PDCP OOOD mode 706 may be disabled for each individual data flow of the one or more data flows of the DRB for which the respective data rate of the corresponding individual data flow is above a threshold. Thus, the PDCP mode selection circuitry 702 may disable the PDCP OOOD mode 706 for data flows with higher data rates and instead select the PDCP Reordering mode 708 for those data flows.

As another example, the PDCP mode selection circuitry 702 may enable the PDCP OOOD mode 706 for each individual data flow of the one or more data flows of the DRB based on a respective type of application associated with each of the data flows. In an example, the PDCP OOOD mode 706 may be enabled for each individual data flow for which the respective type of application is a low-latency application (e.g., XR/VR application, gaming application, conferencing application, telephony application). For other types of applications, the PDCP mode selection circuitry 702 may disable the PDCP OOOD mode 706 and instead select the PDCP Reordering mode 708 for those data flows.

As another example, the PDCP mode selection circuitry 702 may enable the PDCP OOOD mode 706 for each individual data flow level of the one or more data flows of the DRB based on a respective round-trip-time (RTT) of each of the data flows. In an example, the PDCP OOOD mode 706 may be enabled for each data flow for which the respective RTT is below a threshold. Similarly, the PDCP mode selection circuitry 702 may disable the PDCP OOOD mode 706 for data flows having respective RTTs greater than or equal to the threshold, and instead select the PDCP Reordering mode 708 for those data flows.

In some examples, the PDCP mode selection circuitry 702 may enable the PDCP OOOD mode for each individual data flow of the one or more data flows of the DRB based on the respective congestion window size of each of the one or more data flows. In an example, the PDCP OOOD mode 706 may be disabled/enabled for data flows for which the congestion window size is above a threshold. In some examples, the congestion window size above the threshold may correspond flows requiring extensive reordering by PDCP, or to a slow start of an initial phase of the TCP congestion control. In the initial phase, the transmitter is ramping up the data rate and is configured to sense how fast the receiver receives packets. If the receiver is receiving packets at a slow rate (e.g., indicating a delay above a threshold), the PDCP OOOD mode 706 may be disabled. If the window reduction (e.g., congestion window size) is above the threshold, the PDCP OOOD mode 706 may be disabled.

In some examples, the PDCP mode selection circuitry 702 may select (e.g., enable) the PDCP OOOD mode 706 for all of the data flows associated with each of one or more DRBs based on radio characteristics 704. The radio characteristics may include, for example, a rate of downlink TCP retransmissions, a scheduling rate and buffering latency at an application layer, at least one of a latency of radio link control (RLC) automatic repeat request (ARQ) or a number of failed hybrid automatic repeat request (HARQ) retransmissions, and/or a radio condition associated with the UE. For example, the radio condition may include an indication that the UE is a cell edge UE or a cell center UE, a quality of signals received by the UE, or a radio feature supported by the UE (e.g., a higher data rate or a lower data rate).

In some examples, the PDCP mode selection circuitry 702 may enable the PDCP OOOD mode 706 for all of the data flows associated with all of the DRBs based on the rate of downlink TCP retransmissions across the DRBs. For example, the PDCP mode selection circuitry 702 may enable the PDCP OOOD mode 706 if the TCP level retransmissions on the downlink are coming in at a rate less than a threshold. Similarly, the PDCP mode selection circuitry 702 may disable the PDCP OOOD mode 706 and select the PDCP Reordering mode 708 if the rate of TCP retransmissions on the downlink is greater than or equal to the threshold.

In some examples, the PDCP mode selection circuitry 702 may enable the PDCP OOOD mode 706 for all of the data flows associated with all of the DRBs based on the scheduling rate and buffering latency at the application layer. For example, the PDCP mode selection circuitry 702 may enable the PDCP OOOD mode 706 if the scheduling rate is greater than a first threshold and the buffering latency is less than a second threshold. Similarly, the PDCP mode selection circuitry 702 may disable the PDCP OOOD mode 706 and select the PDCP reordering mode 708 if the scheduling rate is less than or equal to the first threshold and/or the buffering latency is greater than or equal to the second threshold.

In some examples, the PDCP mode selection circuitry 702 may enable the PDCP OOOD mode 706 for all of the data flows associated with all of the DRBs based on the latency of RLC ARQ (i.e. time between sending RLC negative ack and receiving the RLC retransmission), and/or the number of failed HARQ retransmissions (i.e. some statistic (average, max, 95% percentile) on number of HARQ transmissions until success). The latency of RLC ARQ indicates how fast RLC ARQ is working and the number of failed HARQ retransmissions indicates the HARQ retransmission success. Both the RLC ARQ latency and number of failed HARQ retransmissions further indicates the gap in time between missing and already received packets at the radio level. For example, the PDCP mode selection circuitry 702 may enable the PDCP OOOD mode 706 if the latency of RLC ARQ is greater than a first threshold and/or the number of failed HARQ retransmissions is greater than a second threshold. Similarly, the PDCP mode selection circuitry 702 may disable the PDCP OOOD mode 706 and select the PDCP reordering mode if the latency of RLC ARQ is less than or equal to the first threshold and/or the number of failed HARQ retransmissions is less than or equal to the second threshold.

In some examples, the PDCP mode selection circuitry 702 may enable the PDCP OOOD mode 706 for all of the data flows associated with all of the DRBs based on the type of radio conditions in which the UE is operating, such as coverage conditions (e.g., cell edge vs. cell center), signal conditions (e.g., good vs. bad), or radio feature set(s) supported (e.g., higher rates vs. lower rates). For example, the PDCP mode selection circuitry 702 may enable the PDCP OOOD mode 706 for UEs at the cell center, for UEs experiencing good signal conditions (e.g., RSRP or SINR above a respective threshold), or for UEs supporting higher data rates. Similarly, the PDCP mode selection circuitry 702 may disable the PDCP OOOD mode 706 and select the PDCP Reordering mode 708 for UEs at the cell edge, for UEs experiencing poor signaling conditions (e.g., RSRP or SINR below the respective threshold), or for UEs supporting only lower data rates.

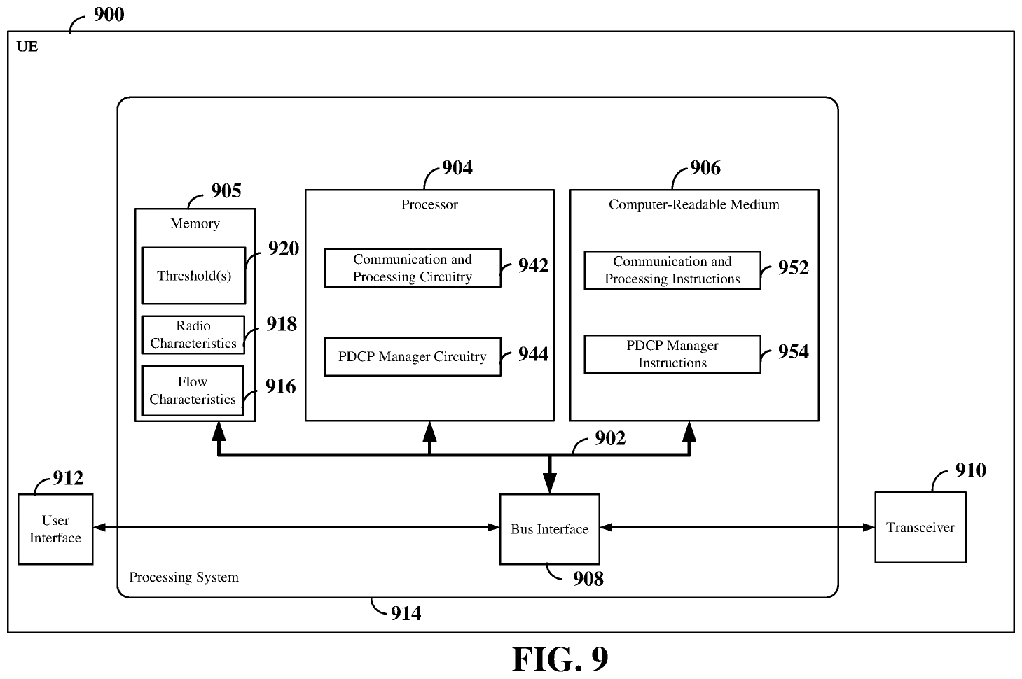

FIG. 9 is a block diagram illustrating an example of a hardware implementation of a user equipment (UE) 900 employing a processing system 914 according to some aspects. The UE 900 may be any of the UEs or other scheduled entities illustrated in any one or more of FIGS. 1, 2, 4, and/or 5.

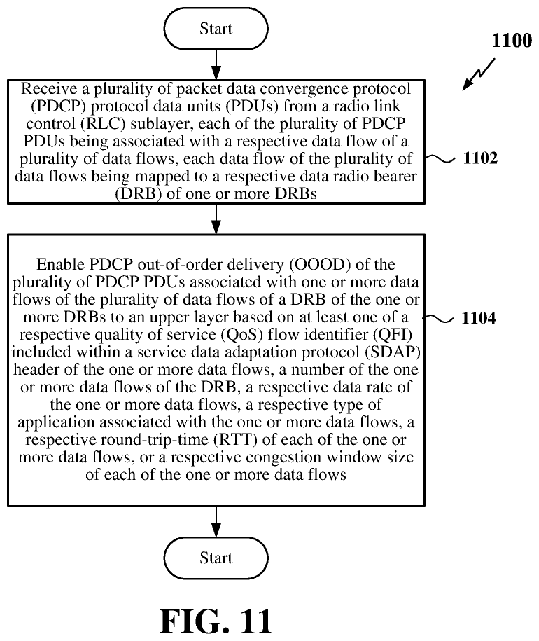

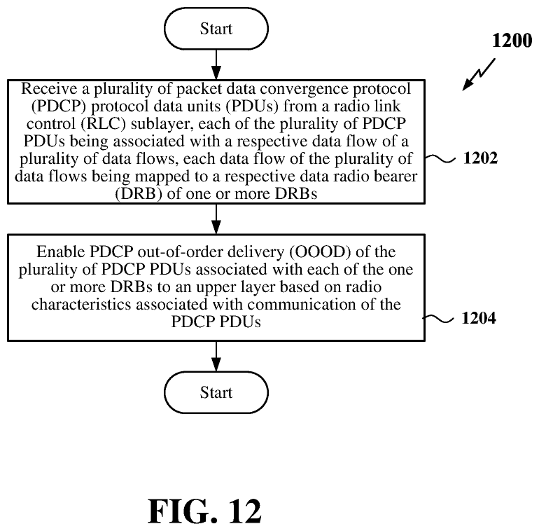

In accordance with various aspects of the disclosure, an element, or any portion of an element, or any combination of elements may be implemented with a processing system 914 that includes one or more processors, such as processor 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 900 may be configured to perform any one or more of the functions described herein. That is, the processor 904, as utilized in the UE 900, may be used to implement any one or more of the methods or processes described and illustrated, for example, in FIGS. 11 and 12.

The processor 904 may in some instances be implemented via a baseband or modem chip and in other implementations, the processor 904 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits, including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, are not described any further.

A bus interface 908 provides an interface between the bus 902 and a transceiver 910. The transceiver 910 may be, for example, a wireless transceiver. The transceiver 910 provides a means for communicating with various other apparatus over a transmission medium (e.g., air interface). The transceiver 910 may further be coupled to one or more antennas/antenna arrays (not shown). The bus interface 908 further provides an interface between the bus 902 and a user interface 912 (e.g., keypad, display, touch screen, speaker, microphone, control features, etc.). Of course, such a user interface 912 may be omitted in some examples.

The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. In some examples, the computer-readable medium 906 may be part of the memory 905. Those skilled in the art will recognize how best to implement the described functionality presented throughout this disclosure depending on the particular application and the overall design constraints imposed on the overall system. In some examples, the computer-readable medium 906 may be implemented on an article of manufacture, which may further include one or more other elements or circuits, such as the processor 904 and/or memory 905.

The computer-readable medium 906 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 904, may be responsible for managing the bus 902 and general processing, including the execution of the software (e.g., instructions or computer-executable code) stored on the computer-readable medium 906. The software, when executed by the processor 904, causes the processing system 914 to perform the various processes and functions described herein for any particular apparatus. The computer-readable medium 906 and/or the memory 905 may also be used for storing data that may be manipulated by the processor 904 when executing software. For example, the memory 905 may store one or more of flow characteristics 916, radio characteristics 918, and/or one or more threshold(s) 920.

In some aspects of the disclosure, the processor 904 may include circuitry configured for various functions. For example, the processor 904 may include communication and processing circuitry 942 configured to communicate with a network entity (e.g., a gNB or eNB). In some examples, the communication and processing circuitry 942 may be configured to communicate with the network entity via two or more TRPs (e.g., in a DC mode). In some examples, the communication and processing circuitry 942 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 942 may include one or more transmit/receive chains. The communication and processing circuitry 942 may further be configured to execute communication and processing instructions (software) 952 stored on the computer-readable medium 906 to implement one or more functions described herein.

In some implementations where the communication involves receiving information, the communication and processing circuitry 942 may obtain information from a component of the UE 900 (e.g., from the transceiver 910 that receives the information via radio frequency signaling or some other type of signaling suitable for the applicable communication medium), process (e.g., decode) the information, and output the processed information. For example, the communication and processing circuitry 942 may output the information to another component of the processor 904, to the memory 905, or to the bus interface 908. In some examples, the communication and processing circuitry 942 may receive one or more of signals, messages, other information, or any combination thereof. In some examples, the communication and processing circuitry 942 may receive information via one or more channels. In some examples, the communication and processing circuitry 942 may include functionality for a means for receiving. In some examples, the communication and processing circuitry 942 may include functionality for a means for processing, including a means for demodulating, a means for decoding, etc.

In some implementations where the communication involves sending (e.g., transmitting) information, the communication and processing circuitry 942 may obtain information (e.g., from another component of the processor 904, the memory 905, or the bus interface 908), process (e.g., modulate, encode, etc.) the information, and output the processed information. For example, the communication and processing circuitry 942 may output the information to the transceiver 910 (e.g., that transmits the information via radio frequency signaling or some other type of signaling suitable for the applicable communication medium). In some examples, the communication and processing circuitry 942 may send one or more of signals, messages, other information, or any combination thereof. In some examples, the communication and processing circuitry 942 may send information via one or more channels. In some examples, the communication and processing circuitry 942 may include functionality for a means for sending (e.g., a means for transmitting). In some examples, the communication and processing circuitry 942 may include functionality for a means for generating, including a means for modulating, a means for encoding, etc.

The processor 904 may further include PDCP manager circuitry 944, configured to receive a plurality of PDCP protocol data units (PDUs) from a radio link control (RLC) sublayer. Each of the plurality of PDCP PDUs is associated with a respective data flow of a plurality of data flows. In addition, each data flow of the plurality of data flows is mapped to a respective data radio bearer (DRB) of one or more DRBs. The PDCP manager circuitry 944 may further be configured to process the PDCP PDUs for transmission to upper layers. The PDCP manager circuitry 944 may correspond, for example, to the PDCP manager circuitry shown in FIGS. 1, 2, and/or 7, and may include the PDCP entit(ies) shown in FIG. 3 and/or FIG. 4. The PDCP manager circuitry 944 may be associated, for example, with a single radio bearer (e.g., DRB) or multiple radio bearers. The PDCP manager circuitry 944 may further be configured to execute PDCP manager instructions (software) 954 stored on the computer-readable medium 906 to implement one or more functions described herein.

In some examples, the PDCP manager circuitry 944 may be configured to enable PDCP out-of-order delivery (OOOD) of the plurality of PDCP PDUs to an upper layer based on at least one of flow characteristics 916 or radio characteristics 918.

In some examples, the PDCP manager circuitry 944 may be configured to enable PDCP OOOD of the plurality of PDCP PDUs associated with one or more data flows of the plurality of data flows of a DRB of the one or more DRBs to an upper layer based on flow characteristics 916 including at least one of the respective QFI included within an SDAP header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

In some examples, the PDCP manager circuitry 944 may be configured to enable the PDCP OOOD for individual data flow of the one or more data flows based on a respective latency indicated by the respective QFI associated with each of the one or more data flows (some QFI values uses OOOD, others do not). In some examples, the PDCP manager circuitry 944 may be configured to enable the PDCP OOOD for each of the one or more data flows of the DRB based on the number of the one or more data flows of the DRB. In some examples, the PDCP manager circuitry 944 may be configured to enable the PDCP OOOD for each of the one or more data flows of the DRB based on the number of the one or more data flows of the DRB being above a first threshold 920 and the periodicity of the DUP ACKs across the one or more data flows being less than a second threshold 920.

In some examples, the PDCP manager circuitry 944 may be configured to enable the PDCP OOOD for each individual data flow of the one or more data flows of the DRB for which the respective type of application is a low-latency application. In some examples, the PDCP manager circuitry 944 may be configured to enable the PDCP OOOD for each individual data flow of the one or more data flows of the DRB for which the respective RTT is below a threshold 920. In some examples, the PDCP manager circuitry 944 may be configured to disable the PDCP OOOD for each individual data flow of the one or more data flows of the DRB for which the congestion window size is above a threshold 920.

In some examples, the PDCP manager circuitry 944 may be configured to enable PDCP OOOD of the plurality of PDCP PDUs associated with each of the one or more DRBs to an upper layer based on radio characteristics 918 associated with communication of the PDCP PDUs. In some examples, the radio characteristics 918 include a rate of downlink transmission control protocol (TCP) retransmissions. In some examples, the radio characteristics 918 include a scheduling rate and buffering latency at an application layer. In some examples, the radio characteristics 918 include at least one of a latency of RLC automatic repeat request (ARQ) or a number of failed hybrid automatic repeat request (HARQ) retransmissions. In some examples, the radio characteristics 918 include a radio condition associated with the UE. For example, the radio condition may include an indication that the UE is a cell edge UE or a cell center UE, a quality of signals received by the UE or a radio feature supported by the UE.

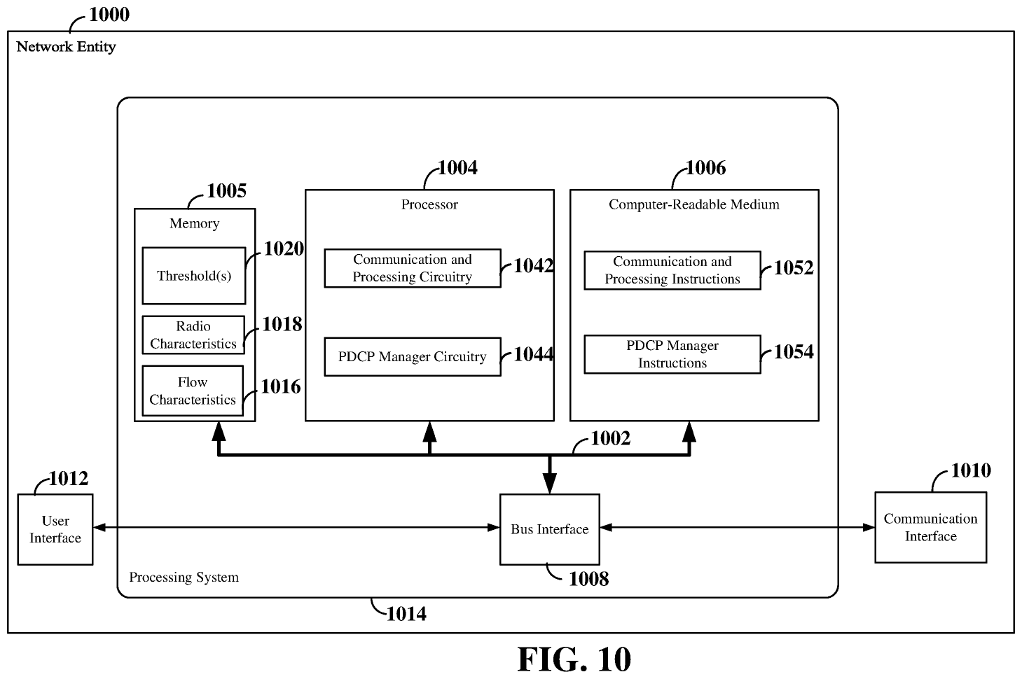

FIG. 10 is a block diagram illustrating an example of a hardware implementation of a network entity 1000 employing a processing system 1014 according to some aspects. The network entity 1000 may be, for example, any base station (e.g., gNB, eNB) or other scheduling entity as illustrated in any one or more of FIGS. 1, 2, and/or 5. The network entity 1000 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, the network entity 1000 may be a stationary network entity or a mobile network entity.

In accordance with various aspects of the disclosure, an element, or any portion of an element, or any combination of elements may be implemented with a processing system 1014 that includes one or more processors, such as processor 1004. The processing system 1014 may be substantially the same as the processing system 914 as shown and described above in connection with FIG. 9, including a bus interface 1008, a bus 1002, a memory 1005, a processor 1004, and a computer-readable medium 1006. Accordingly, their descriptions will not be repeated for the sake of brevity. Furthermore, the network entity 1000 may include an optional user interface 1012 and a communication interface 1010 (e.g., wired or wireless), such as a transceiver or network interface.

The processor 1004, as utilized in the network entity 1000, may be used to implement any one or more of the processes described below. In some examples, the memory 1005 may store flow characteristics 1016, radio characteristics 1018, and/or one or more threshold(s) 1020.

In some aspects of the disclosure, the processor 1004 may include communication and processing circuitry 1042 configured for various functions, including, for example, communicating with one or more UEs or other scheduled entities, or a core network node. In some examples, the communication and processing circuitry 1042 may communicate with one or more UEs via one or more TRPs associated with the network entity 1000. In some examples (e.g., in an aggregated base station architecture), the communication and processing circuitry 1042 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 1042 may be configured to process and transmit downlink traffic and downlink control and receive and process uplink traffic and uplink control. The communication and processing circuitry 1042 may further be configured to execute communication and processing software 1052 stored on the computer-readable medium 1006 to implement one or more functions described herein.

The processor 1004 may further include PDCP manager circuitry 1044, configured to receive a plurality of PDCP protocol data units (PDUs) from a radio link control (RLC) sublayer. Each of the plurality of PDCP PDUs is associated with a respective data flow of a plurality of data flows. In addition, each data flow of the plurality of data flows is mapped to a respective data radio bearer (DRB) of one or more DRBs. The PDCP manager circuitry 1044 may further be configured to process the PDCP PDUs for transmission to upper layers. The PDCP manager circuitry 1044 may correspond, for example, to the PDCP manager circuitry shown in FIGS. 1, 2, and/or 7, and may include the PDCP entit(ies) shown in FIG. 3 and/or FIG. 4. The PDCP manager circuitry 1044 maybe associated, for example, with a single radio bearer (e.g., DRB) or multiple radio bearers. The PDCP manager circuitry 1044 may further be configured to execute PDCP manager instructions (software) 1054 stored on the computer-readable medium 1006 to implement one or more functions described herein.

In some examples, the PDCP manager circuitry 1044 maybe configured to enable PDCP out-of-order delivery (OOOD) of the plurality of PDCP PDUs to an upper layer based on at least one of flow characteristics 1016 or radio characteristics 1018.

In some examples, the PDCP manager circuitry 1044 maybe configured to enable PDCP OOOD of the plurality of PDCP PDUs associated with one or more data flows of the plurality of data flows of a DRB of the one or more DRBs to an upper layer based on flow characteristics 1016 including at least one of a respective QFI included within an SDAP header of the one or more data flows, a number of the one or more data flows of the DRB, a respective data rate of the one or more data flows, a respective type of application associated with the one or more data flows, a respective round-trip-time (RTT) of each of the one or more data flows, or a congestion window size of each of the one or more data flows.

In some examples, the PDCP manager circuitry 1044 maybe configured to enable the PDCP OOOD for each individual data flow of the one or more data flows based on a respective latency indicated by the respective QFI associated with each of the one or more data flows. In some examples, the PDCP manager circuitry 1044 maybe configured to enable the PDCP OOOD for each of the one or more data flows of the DRB based on the number of the one or more data flows of the DRB. In some examples, the PDCP manager circuitry 1044 maybe configured to enable the PDCP OOOD for each of the one or more data flows of the DRB based on the number of the one or more data flows of the DRB being above a first threshold 1020 and the periodicity of the DUP ACKs across the one or more data flows being less than a second threshold 1020.

In some examples, the PDCP manager circuitry 1044 maybe configured to enable the PDCP OOOD for each individual data flow of the one or more data flows of the DRB for which the respective type of application is a low-latency application. In some examples, the PDCP manager circuitry 1044 maybe configured to enable the PDCP OOOD for each individual data flow of the one or more data flows of the DRB for which the respective RTT is below a threshold 1020. In some examples, the PDCP manager circuitry 1044 maybe configured to disable the PDCP OOOD for each individual data flow of the one or more data flows of the DRB for which the congestion window size is above a threshold 1020.

In some examples, the PDCP manager circuitry 1044 maybe configured to enable PDCP OOOD of the plurality of PDCP PDUs associated with each of the one or more DRBs to an upper layer based on radio characteristics 1018 associated with communication of the PDCP PDUs. In some examples, the radio characteristics 1018 include a rate of downlink transmission control protocol (TCP) retransmissions. In some examples, the radio characteristics 1018 include a scheduling rate and buffering latency at an application layer. In some examples, the radio characteristics 1018 include at least one of a latency of RLC automatic repeat request (ARQ) or a number of failed hybrid automatic repeat request (HARQ) retransmissions. In some examples, the radio characteristics 1018 include a radio condition associated with the UE. For example, the radio condition may include an indication that the UE is a cell edge UE or a cell center UE, a quality of signals received by the UE or a radio feature supported by the UE.

FIG. 11 is a flow chart illustrating an exemplary method 1100 for enabling PDCP OOOD according to some aspects. As described below, some or all illustrated features may be omitted in a particular implementation within the scope of the present disclosure, and some illustrated features may not be required for implementation of all embodiments. In some examples, the method 1100 maybe carried out by the UE 900 illustrated in FIG. 9 or the network entity 1000 illustrated in FIG. 10. In some examples, the method 1100 maybe carried out by any suitable apparatus or means for carrying out the functions or algorithm described below. For simplicity, the method 1100 is described below as being implemented by an apparatus, which may correspond to or be included within the UE 900 or network entity 1000.

At block 1102, the apparatus may receive a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs For example, the communication and processing circuitry 942 or 1042 together with the PDCP manager circuitry 944 or 1044 shown and described above in reference to FIG. 9 or 10, may provide a means to receive the plurality of PDCP PDUs.

At block 1104, the apparatus may enable PDCP OOOD of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows. For example, the PDCP manager circuitry 944 or 1044 shown and described above in reference to FIG. 9 or 10 may provide a means to enable PDCP OOOD.

In some examples, the apparatus may further enable the PDCP OOOD for each individual data flow of the one or more data flows based on a respective latency indicated by the respective QFI associated with each of the one or more data flows.

In some examples, the apparatus may further enable the PDCP OOOD for each of the one or more data flows of the DRB based on the number of the one or more data flows of the DRB. For example, the apparatus may enable the PDCP OOOD for each of the one or more data flows of the DRB based on the number of the one or more data flows of the DRB being above a first threshold and the periodicity of the DUP ACKs across the one or more data flows being less than a second threshold.

In some examples, the apparatus may disable the PDCP OOOD for each individual data flow of the one or more data flows of the DRB experiencing DUP ACKs for which the respective data rate of the corresponding individual data flow is above a threshold.

In some examples, the apparatus may enable the PDCP OOOD for each individual data flow of the one or more data flows of the DRB for which the respective type of application is a low-latency application.

In some examples, the apparatus may enable the PDCP OOOD for each individual data flow of the one or more data flows of the DRB for which the respective RTT is below a threshold.

In some examples, the apparatus may disable the PDCP OOOD for each individual data flow of the one or more data flows of the DRB for which the congestion window size is above a threshold.

In one configuration, the UE includes means for receiving a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs, and means for enabling PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1, 2, 4, 5, and/or 7, and utilizing, for example, the processes and/or algorithms described herein in relation to FIG. 11.

In one configuration, the network entity includes means for receiving a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs, and means for enabling PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a periodicity of duplicate transport control protocol (TCP) acknowledgements (DUP ACKs) on an uplink corresponding to the one or more data flows, a respective data rate of the one or more data flows, a respective type of application associated with the one or more data flows, a respective round-trip-time (RTT) of each of the one or more data flows, or a respective congestion window size of each of the one or more data flows. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 4, 5, and/or 7, and utilizing, for example, the processes and/or algorithms described herein in relation to FIG. 11.

FIG. 12 is a flow chart illustrating another exemplary method 1200 for enabling PDCP OOOD according to some aspects. As described below, some or all illustrated features may be omitted in a particular implementation within the scope of the present disclosure, and some illustrated features may not be required for implementation of all embodiments. In some examples, the method 1200 maybe carried out by the UE 900 illustrated in FIG. 9 or the network entity 1000 illustrated in FIG. 10. In some examples, the method 1200 maybe carried out by any suitable apparatus or means for carrying out the functions or algorithm described below. For simplicity, the method 1200 is described below as being implemented by an apparatus, which may correspond to or be included within the UE 900 or network entity 1000.

At block 1202, the apparatus may receive a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs For example, the communication and processing circuitry 942 or 1042 together with the PDCP manager circuitry 944 or 1044 shown and described above in reference to FIG. 9 or 10, may provide a means to receive the plurality of PDCP PDUs.

At block 1204, the apparatus may enable PDCP OOOD of the plurality of PDCP PDUs associated with each of the one or more DRBs to an upper layer based on radio characteristics associated with communication of the PDCP PDUs. In some examples, the radio characteristics may include a rate of downlink transmission control protocol (TCP) retransmissions. In some examples, the radio characteristics may include a scheduling rate and buffering latency at an application layer. In some examples, the radio characteristics may include at least one of a latency of RLC automatic repeat request (ARQ) or a number of failed hybrid automatic repeat request (HARQ) retransmissions. In some examples, the radio characteristics may include a radio condition associated with the UE. For example, the radio condition may include an indication that the UE is a cell edge UE or a cell center UE, a quality of signals received by the UE, or a radio feature supported by the UE. For example, the PDCP manager circuitry 944 or 1044 shown and described above in reference to FIG. 9 or 10 may provide a means to enable PDCP OOOD.

In one configuration, the UE includes means for receiving a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs, and means for enabling PDCP out-of-order delivery (OOOD) of the plurality of PDCP PDUs associated with each of the one or more DRBs to an upper layer based on radio characteristics associated with communication of the PDCP PDUs. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1, 2, 4, 5, and/or 7, and utilizing, for example, the processes and/or algorithms described herein in relation to FIG. 12.

In one configuration, the network entity includes means for receiving a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs, and means for enabling PDCP out-of-order delivery (OOOD) of the plurality of PDCP PDUs associated with each of the one or more DRBs to an upper layer based on radio characteristics associated with communication of the PDCP PDUs. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 4, 5, and/or 7, and utilizing, for example, the processes and/or algorithms described herein in relation to FIG. 12.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN

Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

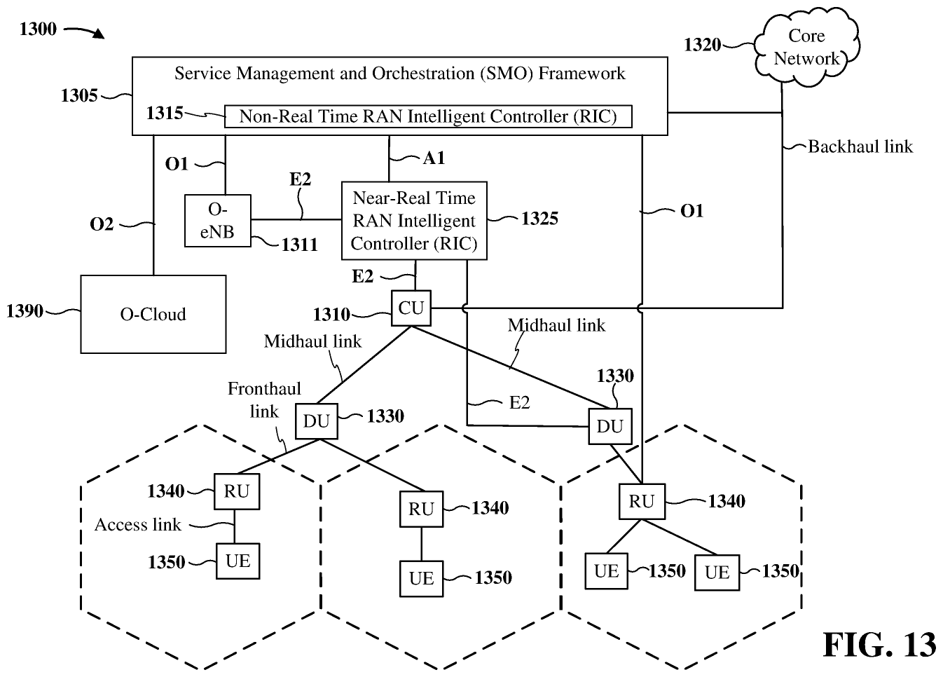

FIG. 13 shows a diagram illustrating an example disaggregated base station 1300 architecture. The disaggregated base station 1300 architecture may include one or more central units (CUs) 1310 that can communicate directly with a core network 1320 via a backhaul link, or indirectly with the core network 1320 through one or more disaggregated base station units (such as a Near-Real Time (Near-RT) RAN Intelligent Controller (RIC) 1325 via an E2 link, or a Non-Real Time (Non-RT) RIC 1315 associated with a Service Management and Orchestration (SMO) Framework 1305, or both). A CU 1310 may communicate with one or more distributed units (DUs) 1330 via respective midhaul links, such as an F1 interface. The DUs 1330 may communicate with one or more radio units (RUs) 1340 via respective fronthaul links. The RUs 1340 may 1340 may communicate with respective UEs 1350 via one or more radio frequency (RF) access links. In some implementations, the UE 1350 maybe simultaneously served by multiple RUs 1340.

Each of the units, i.e., the CUs 1310, the DUs 1330, the RUs 1340, as well as the Near-RT RICs 1325, the Non-RT RICs 1315 and the SMO Framework 1305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1310 mayhost one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1310. The CU 1310 maybe configured to handle user plane functionality (i.e., Central Unit-User Plane (CU-UP)), control plane functionality (i.e., Central Unit-Control Plane (CU-CP)), or a combination thereof. In some implementations, the CU 1310 can be logically split into one or more CU-UP units and one or more CU-CP units. The CU-UP unit can communicate bidirectionally with the CU-CP unit via an interface, such as the E1 interface when implemented in an O-RAN configuration. The CU 1310 can be implemented to communicate with the DU 1330, as necessary, for network control and signaling.

The DU 1330 may correspond to a logical unit that includes one or more base station functions to control the operation of one or more RUs 1340. In some aspects, the DU 1330 mayhost one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1330 may further host one or more low PHY layers. Each layer (or module) can be implemented with an interface configured to communicate signals with other layers (and modules) hosted by the DU 1330, or with the control functions hosted by the CU 1310.

Lower-layer functionality can be implemented by one or more RUs 1340. In some deployments, an RU 1340, controlled by a DU 1330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1340 can be implemented to handle over the air (OTA) communication with one or more UEs 1350. In some implementations, real-time and non-real-time aspects of control and user plane communication with the RU(s) 1340 can be controlled by the corresponding DU 1330. In some scenarios, this configuration can enable the DU(s) 1330 and the CU 1310 to be implemented in a cloud-based RAN architecture, such as a vRAN architecture.

The SMO Framework 1305 maybe configured to support RAN deployment and provisioning of non-virtualized and virtualized network elements. For non-virtualized network elements, the SMO Framework 1305 maybe configured to support the deployment of dedicated physical resources for RAN coverage requirements which may be managed via an operations and maintenance interface (such as an O1 interface). For virtualized network elements, the SMO Framework 1305 maybe configured to interact with a cloud computing platform (such as an open cloud (O-Cloud) 1390) to perform network element life cycle management (such as to instantiate virtualized network elements) via a cloud computing platform interface (such as an O2 interface). Such virtualized network elements can include, but are not limited to, CUs 1310, DUs 1330, RUs 1340 and Near-RT RICs 1325. In some implementations, the SMO Framework 1305 can communicate with a hardware aspect of a 5G RAN, such as an open eNB (O-eNB) 1311, via an O1 interface. Additionally, in some implementations, the SMO Framework 1305 can communicate directly with one or more RUs 1340 via an O1 interface. The SMO Framework 1305 also may include a Non-RT RIC 1315 configured to support functionality of the SMO Framework 1305.

The Non-RT RIC 1315 maybe configured to include a logical function that enables non-real-time control and optimization of RAN elements and resources, Artificial Intelligence/Machine Learning (AI/ML) workflows including model training and updates, or policy-based guidance of applications/features in the Near-RT RIC 1325. The Non-RT RIC 1315 maybe coupled to or communicate with (such as via an A1 interface) the Near-RT RIC 1325. The Near-RT RIC 1325 maybe configured to include a logical function that enables near-real-time control and optimization of RAN elements and resources via data collection and actions over an interface (such as via an E2 interface) connecting one or more CUs 1310, one or more DUs 1330, or both, as well as an O-eNB, with the Near-RT RIC 1325.

In some implementations, to generate AI/ML models to be deployed in the Near-RT RIC 1325, the Non-RT RIC 1315 may receive parameters or external enrichment information from external servers. Such information may be utilized by the Near-RT RIC 1325 and may be received at the SMO Framework 1305 or the Non-RT RIC 1315 from non-network data sources or from network functions. In some examples, the Non-RT RIC 1315 or the Near-RT RIC 1325 maybe configured to tune RAN behavior or performance. For example, the Non-RT RIC 1315 may monitor long-term trends and patterns for performance and employ AI/ML models to perform corrective actions through the SMO Framework 1305 (such as reconfiguration via O1) or via creation of RAN management policies (such as A1 policies).

The following provides an overview of aspects of the present disclosure:

Aspect 1: A method for wireless communication at an apparatus, the method comprising: receiving a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs; and enabling PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

Aspect 2: The method of aspect 1, wherein the enabling the PDCP OOOD of the plurality of PDCP PDUs associated with the one or more data flows of the plurality of data flows of the DRB of the one or more DRBs to the upper layer further comprises: enabling the PDCP OOOD for each individual data flow of the one or more data flows based on a respective latency indicated by the respective QFI associated with each of the one or more data flows.

Aspect 3: The method of aspect 1, wherein the enabling the PDCP OOOD of the plurality of PDCP PDUs associated with the one or more data flows of the plurality of data flows of the DRB of the one or more DRBs to the upper layer further comprises: enabling the PDCP OOOD for each of the one or more data flows of the DRB based on the number of the one or more data flows of the DRB.

Aspect 4: The method of aspect 3, wherein the enabling the PDCP OOOD for each of the one or more data flows of the DRB based on the number of the one or more data flows of the DRB further comprises: enabling the PDCP OOOD for each of the one or more data flows of the DRB based on the number of the one or more data flows of the DRB being above a first threshold and a periodicity of duplicate downlink transport control protocol (TCP) acknowledgements (DUP ACKs) across the one or more data flows being less than a second threshold.

Aspect 5: The method of aspect 1, further comprising: disabling the PDCP OOOD for each individual data flow of the one or more data flows of the DRB for which the respective data rate of the corresponding individual data flow is above a threshold.

Aspect 6: The method of aspect 1, wherein the enabling the PDCP OOOD of the plurality of PDCP PDUs associated with the one or more data flows of the plurality of data flows of the DRB of the one or more DRBs to the upper layer further comprises: enabling the PDCP OOOD for each individual data flow of the one or more data flows of the DRB for which the respective type of application is a low-latency application.

Aspect 7: The method of aspect 1, wherein the enabling the PDCP OOOD of the plurality of PDCP PDUs associated with the one or more data flows of the plurality of data flows of the DRB of the one or more DRBs to the upper layer further comprises: enabling the PDCP OOOD for each individual data flow of the one or more data flows of the DRB for which the respective RTT is below a threshold.

Aspect 8: The method of aspect 1, further comprising: disabling the PDCP OOOD for each individual data flow of the one or more data flows of the DRB for which the congestion window size is above a threshold.

Aspect 9: A method for wireless communication at a user equipment (UE), the method comprising: receiving a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs; and enabling PDCP out-of-order delivery (OOOD) of the plurality of PDCP PDUs associated with each of the one or more DRBs to an upper layer based on radio characteristics associated with communication of the PDCP PDUs.

Aspect 10: The method of aspect 9, wherein the radio characteristics comprise a rate of downlink transmission control protocol (TCP) retransmissions.

Aspect 11: The method of aspect 9, wherein the radio characteristics comprise a scheduling rate and buffering latency at an application layer.

Aspect 12: The method of aspect 9, wherein the radio characteristics comprise at least one of a latency of RLC automatic repeat request (ARQ) or a number of failed hybrid automatic repeat request (HARQ) retransmissions.

Aspect 13: The method of aspect 9, wherein the radio characteristics comprise a radio condition associated with the UE.

Aspect 14: The method of aspect 13, wherein the radio condition comprises an indication that the UE is a cell edge UE or a cell center UE, a quality of signals received by the UE or a radio feature supported by the UE.

Aspect 15: An apparatus comprising a memory and a processor coupled to the memory, the processor configured to perform a method of any one of aspects 1 through 8 or 9 through 14.

Aspect 16: An apparatus comprising means for performing a method of any one of aspects 1 through 8 or 9 through 14.

Aspect 17: A non-transitory computer-readable medium having stored therein instructions executable by one or more processors of an apparatus to perform a method of any one of aspects 1 through 8 or 9 through 14.

Aspect 18: The method of any of aspects 1 through 8 or 9 through 14, wherein the apparatus is a user equipment (UE).

Aspect 19: The method of any of aspects 1 through 8 or 9 through 14, wherein the apparatus is a network entity.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 maybe rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 5, 7, 9, and/or 10 maybe configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus for wireless communication at a user equipment (UE), comprising:
a memory; and
a processor coupled to the memory, the processor configured to:
receive a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs; and
enable PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

2. The apparatus of claim 1, wherein the processor is further configured to:
enable the PDCP OOOD for each individual data flow of the one or more data flows based on a respective latency indicated by the respective QFI associated with each of the one or more data flows.

3. The apparatus of claim 1, wherein the processor is further configured to:
enable the PDCP OOOD for each of the one or more data flows of the DRB based on the number of the one or more data flows of the DRB.

4. The apparatus of claim 3, wherein the processor is further configured to:
enable the PDCP OOOD for each of the one or more data flows of the DRB based on the number of the one or more data flows of the DRB being above a first threshold and a periodicity of duplicate downlink transport control protocol (TCP) acknowledgements (DUP ACKs) across the one or more data flows being less than a second threshold.

5. The apparatus of claim 1, wherein the processor is further configured to:
disable the PDCP OOOD for each individual data flow of the one or more data flows of the DRB for which the respective data rate of the corresponding individual data flow is above a threshold.

6. The apparatus of claim 1, wherein the processor is further configured to:
enable the PDCP OOOD for each individual data flow of the one or more data flows of the DRB for which the respective type of application is a low-latency application.

7. The apparatus of claim 1, wherein the processor is further configured to:
enable the PDCP OOOD for each individual data flow of the one or more data flows of the DRB for which the respective RTT is below a threshold.

8. The apparatus of claim 1, wherein the processor is further configured to:
disable the PDCP OOOD for each individual data flow of the one or more data flows of the DRB for which the congestion window size is above a threshold.

9. An apparatus for wireless communication at a network entity, comprising:
a memory; and
a processor coupled to the memory, the processor configured to:
receive a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs; and
enable PDCP out-of-order delivery (OOOD) of the plurality of PDCP PDUs associated with one or more data flows of the plurality of data flows of a DRB of the one or more DRBs to an upper layer based on at least one of a respective quality of service (QoS) flow identifier (QFI) included within a service data adaptation protocol (SDAP) header of the one or more data flows, a number of the one or more data flows of the DRB, a respective data rate of the one or more data flows, a respective type of application associated with the one or more data flows, a respective round-trip-time (RTT) of each of the one or more data flows, or a respective congestion window size of each of the one or more data flows.

10. The apparatus of claim 9, wherein the processor is further configured to:
enable the PDCP OOOD for each individual data flow of the one or more data flows based on a respective latency indicated by the respective QFI associated with each of the one or more data flows.

11. The apparatus of claim 9, wherein the processor is further configured to:
enable the PDCP OOOD for each of the one or more data flows of the DRB based on the number of the one or more data flows of the DRB.

12. The apparatus of claim 11, wherein the processor is further configured to:
enable the PDCP OOOD for each of the one or more data flows of the DRB based on the number of the one or more data flows of the DRB being above a first threshold and a periodicity of duplicate downlink transport control protocol (TCP) acknowledgements (DUP ACKs) across the one or more data flows being less than a second threshold.

13. The apparatus of claim 9, wherein the processor is further configured to:
disable the PDCP OOOD for each individual data flow of the one or more data flows of the DRB for which the respective data rate of the corresponding individual data flow is above a threshold.

14. The apparatus of claim 9, wherein the processor is further configured to:
enable the PDCP OOOD for each individual data flow of the one or more data flows of the DRB for which the respective type of application is a low-latency application.

15. The apparatus of claim 9, wherein the processor is further configured to:
enable the PDCP OOOD for each individual data flow of the one or more data flows of the DRB for which the respective RTT is below a threshold.

16. The apparatus of claim 9, wherein the processor is further configured to:
disable the PDCP OOOD for each individual data flow of the one or more data flows of the DRB for which the congestion window size is above a threshold.

17. An apparatus for wireless communication at a user equipment (UE), comprising:
a memory; and
a processor coupled to the memory, the processor being configured to:
receive a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs; and
enable PDCP out-of-order delivery (OOOD) of the plurality of PDCP PDUs associated with each of the one or more DRBs to an upper layer based on radio characteristics associated with communication of the PDCP PDUs.

18. The apparatus of claim 17, wherein the radio characteristics comprise a rate of downlink transmission control protocol (TCP) retransmissions.

19. The apparatus of claim 17, wherein the radio characteristics comprise a scheduling rate and buffering latency at an application layer.

20. The apparatus of claim 17, wherein the radio characteristics comprise at least one of a latency of RLC automatic repeat request (ARQ) or a number of failed hybrid automatic repeat request (HARQ) retransmissions.

21. The apparatus of claim 17, wherein the radio characteristics comprise a radio condition associated with the UE.

22. The apparatus of claim 21, wherein the radio condition comprises an indication that the UE is a cell edge UE or a cell center UE, a quality of signals received by the UE or a radio feature supported by the UE.

23. An apparatus for wireless communication at a network entity, comprising:
a memory; and
a processor coupled to the memory, the processor being configured to:
receive a plurality of packet data convergence protocol (PDCP) protocol data units (PDUs) from a radio link control (RLC) sublayer, each of the plurality of PDCP PDUs being associated with a respective data flow of a plurality of data flows, each data flow of the plurality of data flows being mapped to a respective data radio bearer (DRB) of one or more DRBs; and
enable PDCP out-of-order delivery (OOOD) of the plurality of PDCP PDUs associated with each of the one or more DRBs to an upper layer based on radio characteristics associated with communication of the PDCP PDUs.

24. The apparatus of claim 23 wherein the radio characteristics comprise a rate of downlink transmission control protocol (TCP) retransmissions.

25. The apparatus of claim 23, wherein the radio characteristics comprise a scheduling rate and buffering latency at an application layer.

26. The apparatus of claim 23, wherein the radio characteristics comprise at least one of a latency of RLC automatic repeat request (ARQ) or a number of failed hybrid automatic repeat request (HARQ) retransmissions.

27. The apparatus of claim 23, wherein the radio characteristics comprise a radio condition associated with a user equipment (UE).

28. The apparatus of claim 27, wherein the radio condition comprises an indication that the UE is a cell edge UE or a cell center UE, a quality of signals received by the UE or a radio feature supported by the UE.
